(19) United States
(12) Patent Application Publication
(10) Pub. No.: US 2024/0334407 A1
(43) Pub. Date: Oct. 3, 2024

(54) COMMUNICATION METHOD AND TERMINAL DEVICE

(71) Applicant: GUANGDONG OPPO MOBILE TELECOMMUNICATIONS CORP., LTD., Dongguan (CN)

(72) Inventors: Shichang ZHANG, Dongguan (CN); Zhenshan ZHAO, Dongguan (CN); Huei-Ming LIN, Taipei (CN)

(21) Appl. No.: 18/740,121

(22) Filed: Jun. 11, 2024

Related U.S. Application Data
(63) Continuation of application No. PCT/CN2021/137899, filed on Dec. 14, 2021.

(51) Int. Cl. H04W 72/0446; H04W 28/26; H04W 72/25; H04W 72/40

(52) U.S. Cl. CPC H04W 72/0446; H04W 28/26; H04W 72/25; H04W 72/40

(57) ABSTRACT

A communication method and a terminal device are provided. The method includes: receiving, by a first terminal device, resource indication information and target data, where the resource indication information is used to indicate a plurality of reserved resources reserved by a second terminal device, and a part of or all of the plurality of reserved resources belong to a first resource; and in a case that there is a conflict on a reserved resource in the first resource, determining, by the first terminal device, based on an association relationship between the reserved resource on which a conflict occurs and a sending manner of a physical sidelink feedback channel PSFCH, a sending manner, associated with the first resource, of a first PSFCH.

### CROSS-REFERENCE TO RELATED APPLICATIONS

This application is a continuation of International Application No. PCT/CN2021/137899, filed on Dec. 14, 2021, the disclosure of which is hereby incorporated by reference in its entirety.

### TECHNICAL FIELD

This application relates to the field of communications technologies, and more specifically, to a communication method and a terminal device.

### BACKGROUND

In a known enhanced resource allocation solution, when a first terminal device detects that there is a conflict on a reserved resource of a second terminal device, the first terminal device may send a first physical sidelink feedback channel (PSFCH) to the second terminal device. The first physical sidelink feedback channel carries a resource conflict indication to indicate that there is a reserved resource on which a conflict occurs in reserved resources of the second terminal device. However, there is a small quantity of resources used to transmit the PSFCH. When the PSFCH is actually transmitted, the PSFCH usually occupies only one symbol in time domain and only one physical resource block (PRB) in frequency domain. Therefore, a capacity of the PSFCH usually has only one bit. If the resource conflict indication directly carries an identifier of the reserved resource on which a conflict occurs, the resource used to transmit the PSFCH cannot carry both the resource conflict indication and a hybrid automatic repeat request (HARQ) feedback.

### SUMMARY

This application provides a communication method and a terminal device, to reduce a quantity of bits occupied by a PSFCH.

According to a first aspect, a communication method is provided, including: receiving, by a first terminal device, resource indication information and target data, where the resource indication information is used to indicate a plurality of reserved resources reserved by a second terminal device, and a part of or all of the plurality of reserved resources belong to a first resource; and in a case that there is a conflict on a reserved resource in the first resource, determining, by the first terminal device based on an association relationship between the reserved resource on which a conflict occurs and a sending manner of a physical sidelink feedback channel PSFCH, a sending manner, associated with the first resource, of a first PSFCH. The first PSFCH carries a first HARQ feedback for the target data and/or a first resource conflict indication. The first resource conflict indication is used to indicate that there is a conflict on a reserved resource in the first resource. The sending manner of the PSFCH includes a sequence of a resource conflict indication that is used to indicate that there is a reserved resource on which a conflict occurs, and/or sending or skipping sending a HARQ feedback.

According to a second aspect, a communication method is provided, including: receiving, by a first terminal device, resource indication information and target data, where the resource indication information is used to indicate a plurality of reserved resources reserved by a second terminal device, and a part of or all of the plurality of reserved resources belong to a first resource; and in a case that there is a conflict on a reserved resource in the first resource, determining, by the first terminal device based on an association relationship between the reserved resource on which a conflict occurs and a sending manner of a physical sidelink feedback channel PSFCH, a sending manner, associated with the first resource, of a first PSFCH. The first PSFCH carries a first HARQ feedback for the target data and/or a first resource conflict indication. The first resource conflict indication is used to indicate that there is a conflict on a reserved resource in the first resource. The sending manner of the PSFCH includes a frequency-domain unit occupied by a conflict indication that is used to indicate that there is a reserved resource on which a conflict occurs, and/or sending or skipping sending a HARQ feedback.

According to a third aspect, a communication method is provided, including: receiving, by a first terminal device, resource indication information and target data, where the resource indication information is used to indicate a plurality of reserved resources reserved by a second terminal device, and the plurality of reserved resources include a first reserved resource; and in a case that there is a conflict on the first reserved resource, determining, by the first terminal device, a sending manner of a first physical sidelink feedback channel PSFCH based on the first reserved resource being a retransmission resource or an initial transmission resource of the target data. The sending manner of the first PSFCH includes carrying, in the first PSFCH, a first HARQ feedback for the target data and/or a first resource conflict indication, and the first resource conflict indication is used to indicate that there is a conflict on the first reserved resource.

According to a fourth aspect, a communication method is provided, including: receiving, by a first terminal device in a first time-domain unit, resource indication information sent by a second terminal device, where the resource indication information is used to indicate a target reserved resource, in a second time-domain unit, of the second terminal device; and sending, by the first terminal device, a resource conflict indication to the second terminal device in a third time-domain unit, where the resource conflict indication is used to indicate that there is a reserved resource on which a conflict occurs in the target reserved resource. A location of the third time-domain unit in time domain is determined based on one or more of the following information: a location of the first time-domain unit in time domain; a location of the second time-domain unit in time domain; a time required for decoding the indication information by the first terminal device; a time required for preparing the resource conflict indication by the first terminal device; a time required for decoding the resource conflict indication by the second terminal device; and a time required for preparing, by the second terminal device, to transmit data on the reserved resource.

According to a fifth aspect, a communication method is provided, including: sending, by a second terminal device, resource indication information and target data to a first terminal device, where the resource indication information is used to indicate a plurality of reserved resources reserved by the second terminal device, and a part of or all of the plurality of reserved resources belong to a first resource; and in a case that there is a conflict on a reserved resource in the first resource, receiving, by the second terminal device, a first physical sidelink feedback channel PSFCH sent by the first terminal device, where a sending manner of the first PSFCH is determined based on the first resource, and an association relationship between the reserved resource on which a conflict occurs and a sending manner of a physical sidelink feedback channel PSFCH. The first PSFCH carries a first HARQ feedback for the target data and/or a first resource conflict indication. The first resource conflict indication is used to indicate that there is a conflict on a reserved resource in the first resource. The sending manner of the PSFCH includes a sequence of a resource conflict indication that is used to indicate that there is a reserved resource on which a conflict occurs, and/or sending or skipping sending a HARQ feedback.

According to a sixth aspect, a communication method is provided, including: sending, by a second terminal device, resource indication information and target data to a first terminal device, where the resource indication information is used to indicate a plurality of reserved resources reserved by the second terminal device, and a part of or all of the plurality of reserved resources belong to a first resource; and in a case that there is a conflict on a reserved resource in the first resource, receiving, by the second terminal device, a first physical sidelink feedback channel PSFCH, where a sending manner of the first PSFCH is determined based on the first resource, and an association relationship between the reserved resource on which a conflict occurs and the sending manner of the PSFCH. The first PSFCH carries a first HARQ feedback for the target data and/or a first resource conflict indication. The first resource conflict indication is used to indicate that there is a conflict on a reserved resource in the first resource. The sending manner of the PSFCH includes a frequency-domain unit occupied by a conflict indication that is used to indicate that there is a reserved resource on which a conflict occurs, and/or sending or skipping sending a HARQ feedback.

According to a seventh aspect, a communication method is provided, including: sending, by a second terminal device, resource indication information and target data to a first terminal device, where the resource indication information is used to indicate a plurality of reserved resources reserved by the second terminal device, and the plurality of reserved resources include a first reserved resource; and in a case that there is a conflict on the first reserved resource, receiving, by the second terminal device, a first physical sidelink feedback channel PSFCH sent by the first terminal device, where a sending manner of the first PSFCH is determined based on the first reserved resource being a retransmission resource or an initial transmission resource of the target data. The sending manner of the first PSFCH includes carrying, in the first PSFCH, a first HARQ feedback for the target data and/or a first resource conflict indication, and the first resource conflict indication is used to indicate that there is a conflict on the first reserved resource.

According to an eighth aspect, a communication method is provided, including: sending, by a second terminal device in a first time-domain unit, resource indication information sent by a first terminal device, where the resource indication information is used to indicate a target reserved resource, in a second time-domain unit, of the second terminal device; and receiving, by the second terminal device in a third time-domain unit, a resource conflict indication sent by the second terminal device, where the resource conflict indication is used to indicate that there is a reserved resource on which a conflict occurs in the target reserved resource. A location of the third time-domain unit in time domain is determined based on one or more of the following information: a location of the first time-domain unit in time domain; a location of the second time-domain unit in time domain; a time required for decoding the indication information by the first terminal device; a time required for preparing the resource conflict indication by the first terminal device; a time required for decoding the resource conflict indication by the second terminal device; and a time required for preparing, by the second terminal device, to transmit data on the reserved resource.

According to a ninth aspect, a first terminal device is provided, including: a receiving unit, configured to receive resource indication information and target data, where the resource indication information is used to indicate a plurality of reserved resources reserved by a second terminal device, and a part of or all of the plurality of reserved resources belong to a first resource; and a processing unit, configured to: in a case that there is a conflict on a reserved resource in the first resource, determine, based on an association relationship between the reserved resource on which a conflict occurs and a sending manner of a physical sidelink feedback channel PSFCH, a sending manner, associated with the first resource, of a first PSFCH. The first PSFCH carries a first HARQ feedback for the target data and/or a first resource conflict indication. The first resource conflict indication is used to indicate that there is a conflict on a reserved resource in the first resource. The sending manner of the PSFCH includes a sequence of a resource conflict indication that is used to indicate that there is a reserved resource on which a conflict occurs, and/or sending or skipping sending a HARQ feedback.

According to a tenth aspect, a first terminal device is provided, including: a receiving unit, configured to receive resource indication information and target data, where the resource indication information is used to indicate a plurality of reserved resources reserved by a second terminal device, and the plurality of reserved resources include a first reserved resource; and a processing unit, configured to: in a case that there is a conflict on the first reserved resource, determine a sending manner of a first physical sidelink feedback channel PSFCH based on the first reserved resource being a retransmission resource or an initial transmission resource of the target data. The sending manner of the first PSFCH includes carrying, in the first PSFCH, a first HARQ feedback for the target data and/or a first resource conflict indication. The first resource conflict indication is used to indicate that there is a conflict on the first reserved resource.

According to an eleventh aspect, a first terminal device is provided, including: a receiving unit, configured to receive, in a first time-domain unit, resource indication information sent by a second terminal device, where the resource indication information is used to indicate a target reserved resource, in a second time-domain unit, of the second terminal device; and a sending unit, configured to send a resource conflict indication to the second terminal device in a third time-domain unit, where the resource conflict indication is used to indicate that there is a reserved resource on which a conflict occurs in the target reserved resource. A location of the third time-domain unit in time domain is determined based on one or more of the following information: a location of the first time-domain unit in time domain; a location of the second time-domain unit in time domain; a time required for decoding the indication information by the first terminal device; a time required for preparing the resource conflict indication by the first terminal device; a time required for decoding the resource conflict indication by the second terminal device; and a time required for preparing, by the second terminal device, to transmit data on the reserved resource.

According to a twelfth aspect, a second terminal device is provided, including: a sending unit, configured to send resource indication information and target data to a first terminal device, where the resource indication information is used to indicate a plurality of reserved resources reserved by the second terminal device, and a part of or all of the plurality of reserved resources belong to a first resource; and a receiving unit, configured to: in a case that there is a conflict on a reserved resource in the first resource, receive a first physical sidelink feedback channel PSFCH sent by the first terminal device, where a sending manner of the first PSFCH is determined based on the first resource and an association relationship between the reserved resource on which a conflict occurs and the sending manner of the PSFCH. The first PSFCH carries a first HARQ feedback for the target data and/or a first resource conflict indication. The first resource conflict indication is used to indicate that there is a conflict on a reserved resource in the first resource. The sending manner of the PSFCH includes a sequence of a resource conflict indication that is used to indicate that there is a reserved resource on which a conflict occurs, and/or sending or skipping sending a HARQ feedback.

According to a thirteenth aspect, a second terminal device is provided, including: a sending unit, configured to send resource indication information and target data to a first terminal device, where the resource indication information is used to indicate a plurality of reserved resources reserved by the second terminal device, and a part of or of the plurality of reserved resources belong to a first resource; and a receiving unit, configured to: in a case that there is a conflict on a reserved resource in the first resource, receive a first physical sidelink feedback channel PSFCH, where a sending manner of the first PSFCH is determined based on the first resource, and an association relationship between the reserved resource on which a conflict occurs and a sending manner of a PSFCH. The first PSFCH carries a first HARQ feedback for the target data and/or a first resource conflict indication. The first resource conflict indication is used to indicate that there is a conflict on a reserved resource in the first resource. The sending manner of the PSFCH includes a frequency-domain unit occupied by a conflict indication that is used to indicate that there is a reserved resource on which a conflict occurs, and/or sending or skipping sending a HARQ feedback.

According to a fourteenth aspect, a second terminal device is provided, including: a sending unit, configured to send resource indication information and target data to a first terminal device, where the resource indication information is used to indicate a plurality of reserved resources reserved by the second terminal device, and the plurality of reserved resources include a first reserved resource; and a receiving unit, configured to: in a case that there is a conflict on the first reserved resource, receive a first physical sidelink feedback channel PSFCH sent by the first terminal device, where a sending manner of the first PSFCH is determined based on the first reserved resource being a retransmission resource or an initial transmission resource of the target data. The sending manner of the first PSFCH includes carrying, in the first PSFCH, a first HARQ feedback for the target data and/or a first resource conflict indication. The first resource conflict indication is used to indicate that there is a conflict on the first reserved resource.

According to a fifteenth aspect, a second terminal device is provided, including: a sending unit, configured to send, in a first time-domain unit, resource indication information to a first terminal device, where the resource indication information is used to indicate a target reserved resource, in a second time-domain unit, of the second terminal device; and a receiving unit, configured to receive, in a third time-domain unit, a resource conflict indication sent by the second terminal device, where the resource conflict indication is used to indicate that there is a reserved resource on which a conflict occurs in the target reserved resource. A location of the third time-domain unit in time domain is determined based on one or more of the following information: a location of the first time-domain unit in time domain; a location of the second time-domain unit in time domain; a time required for decoding the indication information by the first terminal device; a time required for preparing the resource conflict indication by the first terminal device; a time required for decoding the resource conflict indication by the second terminal device; and a time required for preparing, by the second terminal device, to transmit data on the reserved resource.

According to a sixteenth aspect, a terminal device is provided, including a processor, a memory, and a communications interface. The memory is configured to store one or more computer programs. The processor is configured to invoke the computer program in the memory to cause the terminal device to execute some or all of the steps in the method according to each of the foregoing aspects.

According to a seventeenth aspect, an embodiment of this application provides a communications system. The system includes the first terminal device and/or the second terminal device described above. In another possible design, the system may further include another device interacting with the terminal device or the network device in the solutions provided in embodiments of this application.

According to an eighteenth aspect, an embodiment of this application provides a computer-readable storage medium. The computer-readable storage medium stores a computer program. The computer program causes a terminal to execute some or all of the steps of the method according to each of the foregoing aspects.

According to a nineteenth aspect, an embodiment of this application provides a computer program product. The computer program product includes a non-transitory computer-readable storage medium that stores a computer program. The computer program is operable to cause a terminal to execute some or all of the steps of the method according to each of the foregoing aspects. In some implementations, the computer program product may be a software installation package.

According to a twentieth aspect, an embodiment of this application provides a chip. The chip includes a memory and a processor. The processor may invoke a computer program from the memory and run the computer program, to implement some or all of the steps of the method according to each of the foregoing aspects.

In this application, the reserved resource on which a conflict occurs is associated with the sending manner of the PSFCH. In this way, the first terminal device can implicitly indicate, to the second terminal device by using the sending manner of the PSFCH, the reserved resource on which a conflict occurs, which is conducive to reducing a quantity of bits required for the resource conflict indication in the PSFCH, thereby avoiding a relatively large quantity of bits of the resource conflict indication caused by directly carrying an identifier of the reserved resource on which a conflict occurs in the resource conflict indication.

### BRIEF DESCRIPTION OF DRAWINGS

FIG. 1 shows a wireless communications system 100 to which an embodiment of this application is applicable.

FIG. 2 is a schematic diagram of sidelink resources occupied by second-order SCI.

FIG. 3 is a schematic diagram of a scenario in which a hidden node exists.

FIG. 4 is a schematic diagram of a scenario in which an exposed terminal exists.

FIG. 5 is a schematic flowchart of a manner 2 of an enhanced resource allocation solution.

FIG. 6 is a schematic flowchart of a communication method according to an embodiment of this application.

FIG. 7 is a schematic flowchart of a communication method according to an embodiment of this application.

FIG. 8 is a schematic flowchart of a communication method according to an embodiment of this application.

FIG. 9 is a schematic diagram of a communication method according to an embodiment of this application.

FIG. 10 is a schematic diagram of a terminal device according to an embodiment of this application.

FIG. 11 is a schematic diagram of a terminal device according to an embodiment of this application.

FIG. 12 is a schematic diagram of a terminal device according to an embodiment of this application.

FIG. 13 is a schematic diagram of a terminal device according to an embodiment of this application.

FIG. 14 is a schematic diagram of a terminal device according to an embodiment of this application.

FIG. 15 is a schematic diagram of a terminal device according to an embodiment of this application.

FIG. 16 is a schematic diagram of a terminal device according to an embodiment of this application.

FIG. 17 is a schematic diagram of a terminal device according to an embodiment of this application.

FIG. 18 is a schematic structural diagram of a communications apparatus according to an embodiment of this application.

### DESCRIPTION OF EMBODIMENTS

The following describes the technical solutions in this application with reference to the accompanying drawings. For ease of understanding, communication processes involved in embodiments of this application are first described below with reference to FIG. 1.

FIG. 1 shows a wireless communications system 100 to which an embodiment of this application is applicable. The wireless communications system 100 may include a network device 110 and terminal devices 121 to 129. The network device 110 may provide communication coverage for a specific geographic area, and may communicate with a terminal device within the coverage area.

In some implementations, terminal devices may communicate with each other through a sidelink (SL). Sidelink communication may also be referred to as proximity services (ProSe) communication, unilateral communication, side link communication, device-to-device (D2D) communication, or the like.

In other words, sidelink data is transmitted between terminal devices through a sidelink. The sidelink data may include data and/or control signalling. In some implementations, the sidelink data may be, for example, a physical sidelink control channel (PSCCH), a physical sidelink shared channel (PSSCH), a PSCCH demodulation reference signal (DMRS), a PSSCH DMRS, a physical sidelink feedback channel (PSFCH), or the like.

Several common sidelink communication scenarios are described below with reference to FIG. 1. Sidelink communication may include four scenarios depending on whether the terminal devices in the sidelink are within the coverage of the network device. In a scenario 1, the terminal devices perform sidelink communication within the coverage of the network device. In a scenario 2, some of the terminal devices perform sidelink communication within the coverage of the network device. In a scenario 3, the terminal devices perform sidelink communication outside the coverage of the network device.

As shown in FIG. 1, in the scenario 1, terminal devices 121 and 122 can communicate with each other through a sidelink, and the terminal devices 121 and 122 are both within the coverage of the network device 110. In other words, the terminal devices 121 and 122 are both within the coverage of the same network device 110. In this scenario, the network device 110 may send configuration signalling to the terminal devices 121 and 122, and accordingly, the terminal devices 121 and 122 communicate with each other through the sidelink based on the configuration signalling.

As shown in FIG. 1, in the scenario 2, terminal devices 123 and 124 can communicate with each other through a sidelink, the terminal device 123 is within the coverage of the network device 110, and the terminal device 124 is outside the coverage of the network device 110. In this scenario, the terminal device 123 receives configuration information from the network device 110, and performs communication through the sidelink based on configuration of the configuration signalling. However, since the terminal device 124 is outside the coverage of the network device 110, the terminal device 124 cannot receive the configuration information from the network device 110. In this case, the terminal device 124 may obtain configuration of sidelink communication based on preconfigured configuration information and/or the configuration information sent by the terminal device 123 within the coverage, to communicate with the terminal device 123 through the sidelink based on the obtained configuration.

In some cases, the terminal device 123 may send the configuration information to the terminal device 124 through a physical sidelink broadcast channel (PSBCH), to configure the terminal device 124 to perform communication through the sidelink.

As shown in FIG. 1, in the scenario 3, terminal devices 125 to 129 are all outside the coverage of the network device 110 and cannot communicate with the network device 110. In this case, all the terminal devices may perform sidelink communication based on preconfiguration information.

In some cases, the terminal devices 127 to 129 outside the coverage of the network device may form a communication cluster, and the terminal devices 127 to 129 in the communication cluster may communicate with each other. In addition, the terminal device 127 in the communication cluster may serve as a central control node, also referred to as a cluster header (CH). Correspondingly, the other terminal devices in the communication cluster may be referred to as “cluster members”.

The terminal device 127 as the CH may have one or more of the following functions: responsible for establishment of the communication cluster; joining and leaving of the cluster members; resource coordination, allocation of sidelink transmission resources for the cluster members, and reception of sidelink feedback information from the cluster members; resource coordination with another communication cluster; and other functions.

It should be noted that FIG. 1 exemplarily shows one network device and a plurality of terminal devices. Optionally, the wireless communications system 100 may include a plurality of network devices, and another quantity of terminal devices may be included in coverage of each network device. This is not limited in embodiments of this application.

Optionally, the wireless communications system 100 may further include other network entities such as a network controller and a mobility management entity. This is not limited in embodiments of this application.

It should be understood that technical solutions in embodiments of this application may be applied to various communications systems, such as a fifth generation (5G) system or new radio (NR), a long term evolution (LTE) system, an LTE frequency division duplex (FDD) system, and LTE time division duplex (TDD). The technical solutions provided in this application may be further applied to a future communications system, such as a sixth generation mobile communications system and a satellite communications system.

The terminal device in embodiments of this application may also be referred to as user equipment (UE), an access terminal, a subscriber unit, a subscriber station, a mobile site, a mobile station (MS), a mobile terminal (MT), a remote station, a remote terminal, a mobile device, a user terminal, a terminal, a wireless communications device, a user agent, or a user apparatus. The terminal device in embodiments of this application may be a device providing a user with voice and/or data connectivity and capable of connecting people, objects, and machines, such as a handheld device or a vehicle-mounted device having a wireless connection function. The terminal device in embodiments of this application may be a mobile phone, a tablet computer (Pad), a notebook computer, a palmtop computer, a mobile internet device (MID), a wearable device, a virtual reality (VR) device, an augmented reality (AR) device, a wireless terminal in industrial control, a wireless terminal in self-driving, a wireless terminal in remote medical surgery, a wireless terminal in a smart grid, a wireless terminal in transportation safety, a wireless terminal in a smart city, a wireless terminal in a smart home, or the like. Optionally, the UE may serve as a base station. For example, the UE may serve as a scheduling entity, and provides sidelink data between UEs in V2X, D2D, or the like. For example, a cellular phone and a car communicate with each other by using sidelink data. A cellular phone and a smart home device communicate with each other, without relay of a communication signal through a base station.

The network device in embodiments of this application may be a device for communicating with a terminal device. The network device may also be referred to as an access network device or a wireless access network device. For example, the network device may be a base station. The network device in embodiments of this application may be a radio access network (RAN) node (or device) via which the terminal device is connected to a wireless network. The base station may broadly cover various names below, or may be replaced with the following names, such as a NodeB, an evolved NodeB (eNB), a next generation NodeB (gNB), a relay station, an access point, a transmitting and receiving point (TRP), a transmitting point (TP), a master MeNB, a secondary SeNB, a multi-standard radio (MSR) node, a home base station, a network controller, an access node, a wireless node, an access point (AP), a transmission node, a transceiver node, a base band unit (BBU), a remote radio unit (RRU), an active antenna unit (AAU), a remote radio head (RRH), a central unit (CU), a distributed unit (DU), and a positioning node. The base station may be a macro base station, a micro base station, a relay node, a donor node, or the like, or a combination thereof. Alternatively, the base station may be a communications module, a modem, or a chip disposed in the device or apparatus described above. Alternatively, the base station may be a mobile switching center, a device that functions as a base station in device to device D2D, vehicle-to-everything (V2X), and machine-to-machine (M2M) communication, a network-side device in a 6G network, a device that functions as a base station in a future communications system, or the like. The base station may support networks of the same or different access technologies. A specific technology and a specific device form used by the network device are not limited in embodiments of this application.

The base station may be fixed or mobile. For example, a helicopter or an unmanned aerial vehicle may be configured to serve as a mobile base station, and one or more cells may move according to a location of the mobile base station. In other examples, a helicopter or an unmanned aerial vehicle may be configured to serve as a device in communication with another base station.

In some deployments, the network device in embodiments of this application may be a CU or a DU, or the network device includes a CU and a DU. The gNB may further include an AAU.

The network device and the terminal device may be deployed on land, including being indoors or outdoors, handheld, or vehicle-mounted, may be deployed on a water surface, or may be deployed on a plane, a balloon, or a satellite in the air. In embodiments of this application, a scenario in which the network device and the terminal device are located is not limited.

It should be understood that all or some of functions of the communications device in this application may also be implemented by software functions running on hardware, or by virtualization functions instantiated on a platform (for example, a cloud platform).

### Sidelink Transmission Manner

With development of automatic driving technologies, the automatic driving technologies may be integrated with a communications system, or data exchange between vehicle-mounted devices needs to be implemented by using a communications system. Therefore, a higher requirement is imposed for communications systems. For example, the communications systems are required to support higher throughput, lower latency, higher reliability, larger coverage, and more flexible resource allocation. In LTE-V2X, only a broadcast manner is supported between terminal devices for sidelink communication. With development of technologies, unicast and multicast transmission manners are introduced into NR-V2X.

For the unicast transmission manner, there is usually only one terminal device that receives sidelink data. With reference to FIG. 1, the terminal device 121 and the terminal device 122 may communicate with each other in the unicast transmission manner. When the terminal device 121 sends sidelink data through a sidelink, the terminal device 122 serves as a unique receiving device to receive the sidelink data.

For the multicast transmission manner, all terminal devices in a communication cluster may receive sidelink data, or all terminal devices within a specific transmission distance may receive sidelink data. For example, with reference to FIG. 1, for a communication cluster including terminal devices 127 to 129, when the terminal device 127 sends sidelink data in a multicast manner, the other terminal devices 128 and 129 in the communication cluster are both receiving terminal devices that receive the sidelink data. For another example, with reference to FIG. 1, it is assumed that terminal devices within a preset range include the terminal devices 127 to 129. In this case, when the terminal device 127 sends sidelink data in the multicast manner, the other terminal devices 128 and 129 within the preset range are both receiving terminal devices that receive the sidelink data.

For the broadcast transmission manner, a terminal device that receives sidelink data may be any terminal device around a terminal device serving as a transmitting end. For example, with reference to FIG. 1, it is assumed that the terminal device 125 serves as a transmitting end and sends sidelink data in the broadcast manner. In this case, any of terminal devices 121 to 124 and terminal devices 126 to 129 around the terminal device 125 may serve as a receiving end of the sidelink data.

### Second-Order SCI Mechanism

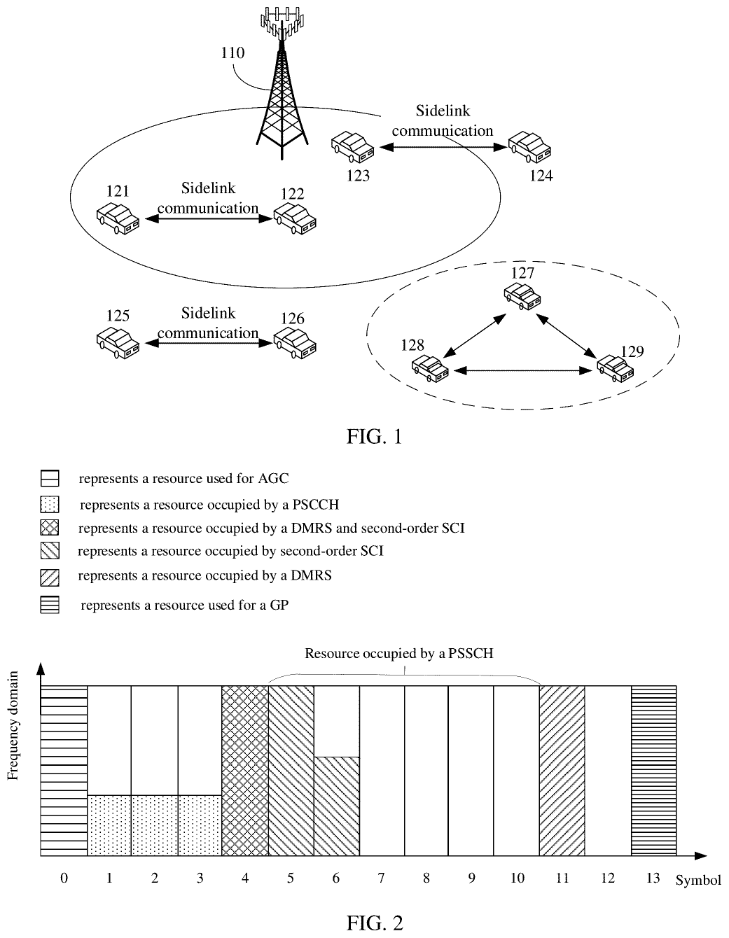

Second-order SCI is introduced into NR-V2X. With reference to FIG. 2, the following describes a sidelink resource occupied by the second-order SCI. With reference to FIG. 2, first-order SCI is carried in a PSCCH. In some implementations, the first-order SCI is used to indicate information such as a sidelink resource occupied by the PSSCH, reserved-resource information, a modulation and coding scheme (MCS) level, and a priority.

The second-order SCI may be transmitted in the PSSCH, and demodulated by using a DMRS of the PSSCH. In some implementations, the PSCCH may occupy three symbols (symbols 1, 2, and 3). The second-order SCI may be mapped from a first DMRS symbol of the PSSCH. The mapping is performed first in frequency domain and then in time domain. The DMRS of the PSSCH occupies symbols 4 and 11. In some other implementations, the second-order SCI is mapped from the symbol 4. The mapping may be continuously performed to a symbol 6. Frequency division multiplexing is performed between the second-order SCI and the DMRS on the symbol 4. A size of the sidelink resource occupied by the second-order SCI depends on a quantity of bits of the second-order SCI. In some implementations, the second SCI may be used to indicate information used for data demodulation, for example, an ID of a transmitting end, an ID of a receiving end, a hybrid automatic repeat request (HARQ) ID, and a new data indicator (NDI).

### Sidelink Resource Allocation Manner

Currently, in some communications systems (for example, NR), two resource configuration manners for sidelink resources are defined, namely, a mode 1 and a mode 2.

In the mode 1, a network device schedules a sidelink resource for a terminal device.

Currently, the mode 1 may include two manners: dynamic resource allocation and sidelink configured grant (SL CG). In the dynamic resource allocation, the network device may allocate a sidelink transmission resource for the terminal device by sending downlink control information (DCI). In the sidelink configured grant manner, after a sidelink resource is configured for the terminal device, if the terminal device has to-be-transmitted data, the terminal device may transmit the data by using the configured sidelink resource without requesting another sidelink resource from the network device. Therefore, a transmission delay of a sidelink can be reduced by using the resource configuration manner of configured grant.

The foregoing configured grant is further divided into two types. In a type 1 (Type1) of the configured grant, sidelink resource configuration is fully based on radio resource control (RRC) signalling. In a type 2 (Type2) of the configured grant, sidelink resource configuration in a communications system may be configured by both RRC signalling and layer 1 (L1) signalling. Herein, the L1 signalling is used to indicate activation and deactivation of RRC configuration.

In some implementations, the network device may schedule a sidelink resource of a single transmission for the terminal device. In some other implementations, the network device may further configure a semi-static sidelink resource for the terminal device.

For example, with reference to FIG. 1, the terminal devices 121 to 123 are within coverage of the network device 110. The network device 110 may allocate sidelink resources for the terminal devices 121 to 123.

In the mode 2, the terminal device independently selects a sidelink resource in a resource pool.

In this mode, a process executed by the terminal device includes a resource probing process and/or a resource selection process. In the resource probing process, the terminal device may identify the occupancy of the sidelink resource by demodulating sidelink control information (SCI). Alternatively, the terminal device may identify the occupancy of the sidelink resources by measuring a received power of the sidelink. For example, with reference to FIG. 1, the terminal devices 124 to 129 are outside the coverage of the network device 110, and the terminal devices 124 to 129 may independently select a sidelink resource in the mode 2.

In some implementations, in the foregoing resource probing process, the terminal device may regard all available resources in a resource selection window as a resource set A.

If the terminal device detects a physical sidelink control channel (PSCCH) in a listening window, the terminal device may measure the detected PSCCH, and determine an available resource in the foregoing resource set A based on a measurement result of the PSCCH.

For example, the terminal device may measure reference signal received power (RSRP) of the PSCCH, or the terminal device may measure RSRP of a physical sidelink shared channel (PSSCH) scheduled by using the PSCCH. If the RSRP measured by the terminal device is greater than an SL-RSRP threshold and it is determined that a reserved resource indicated by SCI transmitted in the PSCCH is in the resource selection window, the terminal device excludes a corresponding reserved resource from the resource set A.

It should be noted that, if a remaining resource in the resource set A is less than X % of all the resources in the resource set A before resource exclusion is performed, the SL-RSRP threshold is increased by 3 dB, and the foregoing resource probing process is executed again. In some implementations, possible values of the parameter X are {20, 35, 50}. Correspondingly, the terminal device may determine the parameter X from the value set of the parameter X based on a priority of to-be-sent data. In addition, the foregoing SL-RSRP threshold is related to a priority carried in the PSCCH detected by the terminal device and a priority of to-be-sent data of the terminal device.

In addition, it is assumed that the terminal device needs to send data in some slots in the listening window, but the terminal device does not perform listening in the listening window. In this case, all sidelink resources of these slots in slots corresponding to the resource selection window are excluded. In other words, the terminal device cannot use all the sidelink resources of these slots in the slots corresponding to the resource selection window. Correspondingly, the terminal device may reselect a sidelink resource of a corresponding slot in the resource selection window by using a value set of a “resource reservation period” field in used resource pool configuration, to transmit the to-be-sent data.

In some other implementations, in the foregoing resource selection process, the terminal device randomly selects several resources from the resource set A as resources for initial transmission of new data (also referred to as “initial transmission resources”) or resources for data retransmission (also referred to as “retransmission resources”).

In the resource allocation manner of the foregoing described mode 2, the terminal device may independently select a sidelink resource from a resource pool based on a listening result. In this listen-before-select resource selection manner, interference between terminal devices can be avoided to some extent. However, there may be problems such as a hidden node, half-duplex, an exposed terminal, and large power consumption of a terminal device. The following separately describes the foregoing problems.

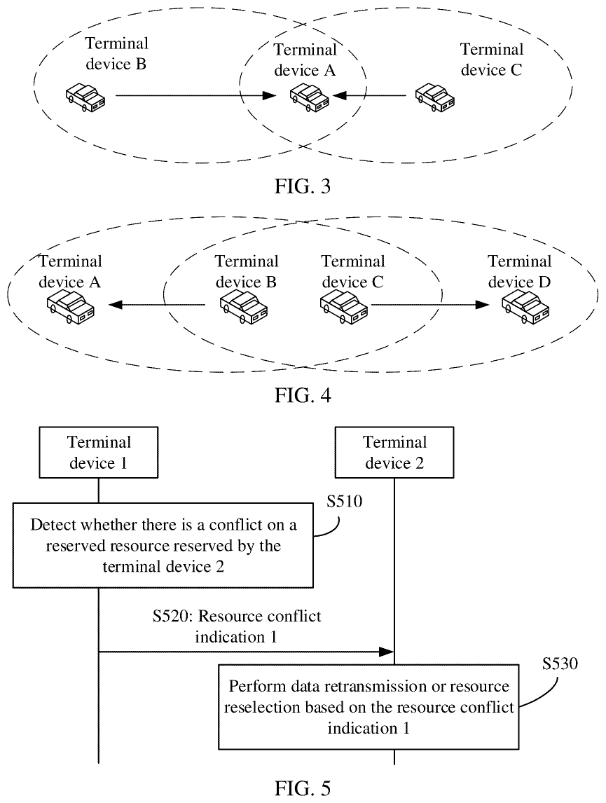

For the problem of a hidden node, FIG. 3 is a schematic diagram of a scenario in which a hidden node exists. In FIG. 3, it is assumed that a terminal device B needs to select a sidelink resource based on a listening result and send sidelink data to a terminal device A by using the selected sidelink resource. Correspondingly, a terminal device C also needs to select a sidelink resource based on a listening result and send sidelink data to the terminal device A based on the selected sidelink resource. However, because the terminal device B and the terminal device C are distant from each other, the terminal device B and the terminal device C cannot detect each other's transmitted signals. In this case, the terminal device B and the terminal device C are hidden nodes to each other. Therefore, the terminal device B and the terminal device C may select a same sidelink resource to send sidelink data to the terminal device A, and interference may occur between the terminal device C and the terminal device B.

For the problem of half-duplex, the terminal device cannot simultaneously send data and listen a sidelink resource. When the terminal device performs listening in the listening window to select a sidelink resource, there is to-be-sent data that needs to be sent in a target slot in the listening window. In this case, due to limitation of half-duplex, the terminal device cannot perform listening on the target slot. Therefore, based on the foregoing descriptions, for a sidelink resource corresponding to the target slot on which listening is not performed, regardless of whether there is actually another terminal device that transmits data on the sidelink resource, the terminal device needs to exclude the sidelink resource from available resources. In other words, the terminal device needs to exclude the sidelink resource corresponding to the target slot in the resource selection window from the resource set A, to avoid interference with another terminal. In this case, the terminal device excludes many sidelink resources that do not need to be excluded.

For the problem of an exposed terminal, FIG. 4 is a schematic diagram of a scenario in which an exposed terminal exists. With reference to FIG. 4, a terminal device B needs to send sidelink data to a terminal device A by using a sidelink resource. In this case, the terminal device A may be referred to as a target receiving terminal of the terminal device B. A terminal device C needs to send sidelink data to a terminal device D by using a sidelink resource. In this case, the terminal device D may be referred to as a target receiving terminal of the terminal device C. It is assumed that because the terminal device B and the terminal device C are close to each other, in a process of performing listening on a sidelink resource, the terminal device B and the terminal device C can detect each other's sent sidelink signals. In this case, the terminal device B and the terminal device C are exposed terminals to each other, and the terminal device B and the terminal device C do not select a same sidelink resource. However, actually, the target receiving terminal A of the terminal device B is distant from the terminal device C, and the target receiving terminal D of the terminal device C is distant from the terminal device B. Even the terminal device B and the terminal device C send their sidelink data using a same sidelink resource, reception of sidelink data of respective target receiving terminals of the terminal device B and the terminal device C is not interfered with. In other words, due to existence of exposed terminals, the terminal device C and the terminal device B cannot transmit their sidelink data on a same sidelink resource, resulting in low utilization efficiency of the sidelink resource.

For the problem of large power consumption of a terminal device, in the resource probing process described above, the terminal device needs to continuously perform listening on a sidelink resource to select a sidelink resource available to the terminal device. Continuous listening performed on a sidelink resource consumes a large amount of power of the terminal device. As a result, the terminal device will soon be powered off. In this case, user experience of a terminal device, that cannot be charged anywhere at any time, such as a handheld terminal is reduced. Therefore, how to reduce power consumption of the terminal device is also a problem that needs to be considered in the resource probing process.

### Enhanced Sidelink Resource Allocation Solution

For problems existing in the foregoing mode 2, currently, an enhanced sidelink resource allocation solution is proposed for sidelink resource selection. Currently, the foregoing enhanced resource allocation solution may include the following two manners.

In a manner 1, another terminal device (also referred to as a “terminal device 1”) may send a reference resource set to a terminal device (also referred to as a “terminal device 2”) that performs resource listening, to assist the terminal device 2 in performing resource selection. A sidelink resource in the reference resource set is an available sidelink resource. In some implementations, the foregoing reference resource set may be an available resource set obtained by the terminal device 1 based on a listening result, an indication of a network device, and the like. In some other implementations, the foregoing reference resource set may be an available sidelink resource determined by the terminal device 1 based on detected SCI. Correspondingly, the terminal device 2 may preferentially select a sidelink resource from the reference resource set to send sidelink data to the terminal device 1. Because a location of the terminal device 1 is different from a location of the terminal device 2, the terminal device 2 may select an appropriate sidelink resource with reference to the reference resource set sent by the terminal device 1, to avoid some problems in the foregoing mode 2, thereby improving reliability of sidelink data received by a target receiving terminal. Usually, the foregoing terminal device 1 is referred to as a “resource coordination terminal”.

It should be noted that the foregoing reference resource set may also include a sidelink resource that is not applicable to the terminal device 2, to help the terminal device 2 exclude an unavailable sidelink resource.

In a manner 2, if the terminal device 1 detects that a collision may occur on a reserved resource reserved by the terminal device 2, the terminal device 1 may send a resource conflict indication (also referred to as a “resource collision indication”) to the terminal device 2 by using a physical sidelink feedback channel (PSFCH), to indicate that there is a conflict on the reserved resource reserved by the terminal device 2. Correspondingly, after receiving the resource conflict indication, the terminal device 2 may learn that there is a reserved resource on which a conflict occurs, and perform corresponding data retransmission or resource reselection. For ease of understanding, the following describes a procedure of the manner 2 of the enhanced resource allocation solution with reference to FIG. 5.

FIG. 5 is a schematic flowchart of a manner 2 of an enhanced resource allocation solution. The method shown in FIG. 5 includes step S510 and step S520.

In step S510, a terminal device 1 detects whether there is a conflict on a reserved resource reserved by a terminal device 2.

In some implementations, the terminal device 1 may learn of the reserved resource reserved by the terminal device 2 by receiving first-order SCI sent by the terminal device 2. If the terminal device 1 detects that there is a conflict on the reserved resource 1 reserved by the terminal device 2, the terminal device 1 may send a resource conflict indication to the terminal device 2, to indicate that there is a conflict on the reserved resource 1.

In step S520, the terminal device 1 sends a resource conflict indication 1 to the terminal device 2.

The resource conflict indication 1 is used to indicate that there is a conflict on the reserved resource 1.

In step S530, the terminal device 2 performs data retransmission or resource reselection based on the resource conflict indication 1.

### PSFCH

As described above, the foregoing resource conflict indication may be carried in a PSFCH for transmission. Therefore, for ease of understanding, the following describes a transmission manner of the PSFCH by taking a PSFCH supported in R16 NR-V2X as an example.

A PSFCH that supports a sequence type in R16 NR-V2X is referred to as a “PSFCH format 0”. Usually, this type of PSFCH uses a sequence type the same as a PUCCH format 0. This type of PSFCH occupies one physical resource block (PRB) in frequency domain, and occupies one orthogonal frequency division multiplexing (OFDM) symbol in time domain. In a resource pool, a sidelink resource used to transmit a PSFCH may be configured by using 1, 2, or 4 slots as a period. In a slot with a PSFCH resource, the PSFCH resource is usually located on a final OFDM symbol, in the slot, that can be used for sidelink sending. In addition, to support transmission/reception conversion and automatic gain control (AGC) adjustment, two OFDM symbols before the PSFCH symbol are respectively used for transmission/reception conversion and AGC adjustment. Usually, a PSCCH and a PSSCH are not allowed to be sent on the foregoing three OFDM symbols. In R16 NR-V2X, the PSFCH is used to carry only HARQ feedback information, and a capacity of one PSFCH is usually one bit.

In some implementations, a sidelink resource occupied by the PSFCH is determined based on a time-frequency location of a transmission resource of a PSSCH corresponding to the PSFCH. In NR-V2X, the following two PSFCH resource determining manners are supported. Which PSFCH resource determining manner to be used may be determined based on higher layer signalling configuration.

In a PSFCH resource determining manner 1, a transmission resource of the PSFCH may be determined based on a first subchannel of a frequency domain resource of the PSSCH.

In a PSFCH resource determining manner 2, a transmission resource of the PSFCH may be determined based on all subchannels occupied by the PSSCH in frequency domain.

For the PSFCH resource determining manner 1, because the transmission resource of the PSFCH is determined based on only the first subchannel occupied by the PSSCH, regardless of how many subchannels occupied by the PSSCH, a quantity of sidelink resources occupied by the PSFCH for the PSSCH is fixed. For the PSFCH resource determining manner 2, a quantity of transmission resources of the PSFCH may be determined based on the quantity of subchannels occupied by the PSSCH. Therefore, more subchannels occupied by the PSSCH correspondingly indicate more sidelink resources occupied by the PSFCH for the PSSCH. Usually, the PSSCH resource determining manner 2 is more applicable to a scenario in which more HARQ feedback resources are needed.

A resource set R_{PRB,CS}^{PSFCH} of the PSFCH for the PSSCH may be determined based on a slot and a subchannel that are occupied by the PSSCH. An index of a sidelink resource, occupied by the PSFCH, in the resource set R_{PRB,CS}^{PSFCH} may be determined first according to an ascending order of resource blocks (RB) and then according to an ascending order of carrier (carrier space, CS) pairs.

In addition, in the resource set R_{PRB,CS}^{PSFCH}, the transmission resource of the PSFCH may be determined according to a formula (P_{ID}+M^{ID})modR_{PRB,CS}^{PSFCH}. Herein, P_{ID} represents a transmitting end ID of sidelink data, that is, a source ID, carried in the SCI, of a transmitting end. For a unicast sidelink HARQ feedback manner or a NACK-only multicast sidelink HARQ feedback manner, M_{ID}=0. For an ACK/NACK multicast sidelink HARQ feedback manner, M_{ID} represents an intra-group identity, configured at a higher layer, of a terminal device of a receiving end of sidelink data.

In NR-V2X, a PSFCH resource may be configured by SL-PSFCH-Config-r16 signalling (refer to pseudo codes shown below). The “sl-PSFCH-Period-r16” field is used to configure a period of a PSFCH resource. The “sl-PSFCH-RB-Set-r16” field is used to configure a PRB, that can be used for sending a PSFCH, on an OFDM symbol on which the PSFCH resource is located. The “sl-NumMuxCS-Pair-r16” field is used to configure a quantity of cyclic shifts of an allowed PSFCH sequence in a PRB. The “sl-MinTimeGapPSFCH-r16” field is used to configure a minimum time interval between a PSFCH and a PSSCH associated with the PSFCH. The “sl-PSFCH-HopID-r16” field is used to configure a frequency hopping ID of the PSFCH. The frequency hopping ID is used to determine the PSFCH sequence. The “sl-PSFCH-CandidateResourceType-r16” field is used to configure a manner of determining a PSFCH candidate resource.

SL-PSFCH-Config-r16 ::= SEQUENCE {

| | |
|---|---|
| sl-PSFCH-Period-r16 ENUMERATED {sl0, sl1, sl2, sl4} | OPTIONAL, |

-- Need M

| | |
|---|---|
| sl-PSFCH-RB-Set-r16 BIT STRING (SIZE (10..275)) | OPTIONAL, |

-- Need M

| | |
|---|---|
| sl-NumMuxCS-Pair-r16 | ENUMERATED {n1, n2, n3, n6} |

OPTIONAL, -- Need M

| | |
|---|---|
| sl-MinTimeGapPSFCH-r16 | ENUMERATED {sl2, sl3} |

OPTIONAL, -- Need M

| | |
|---|---|
| sl-PSFCH-HopID-r16 INTEGER (0..1023) | OPTIONAL, |

-- Need M

| | |
|---|---|
| sl-PSFCH-CandidateResourceType-r16 | ENUMERATED {startSubCH, allocSubCH} |

OPTIONAL, -- Need M
...
}

As described above, in the manner 2 of the enhanced resource allocation solution, when the terminal device 1 (also referred to as a “first terminal device”) detects that there is a conflict on the reserved resource of the terminal device 2 (also referred to as a “second terminal device”), the terminal device 1 may send a PSFCH (also referred to as a “first PSFCH”) to the terminal device 2 to carry the resource conflict indication. However, as described above, there is a small quantity of resources used to transmit the PSFCH. In addition, when the PSFCH is actually transmitted, the PSFCH usually occupies only one symbol in time domain and only one PRB in frequency domain. Therefore, a capacity of the PSFCH usually has only one bit. If the resource conflict indication directly carries an identifier of the reserved resource on which a conflict occurs, the resource used to transmit the PSFCH cannot carry both the resource conflict indication and a HARQ feedback.

Therefore, to reduce a quantity of bits occupied by the resource conflict indication, this application provides a communication method. A reserved resource on which a conflict occurs is associated with a sending manner of a PSFCH. In this way, the reserved resource on which a conflict occurs is implicitly indicated by using the sending manner of the PSFCH, thereby avoiding a relatively large quantity of bits of a resource conflict indication caused by directly carrying an identifier of the reserved resource on which a conflict occurs in the resource conflict indication.

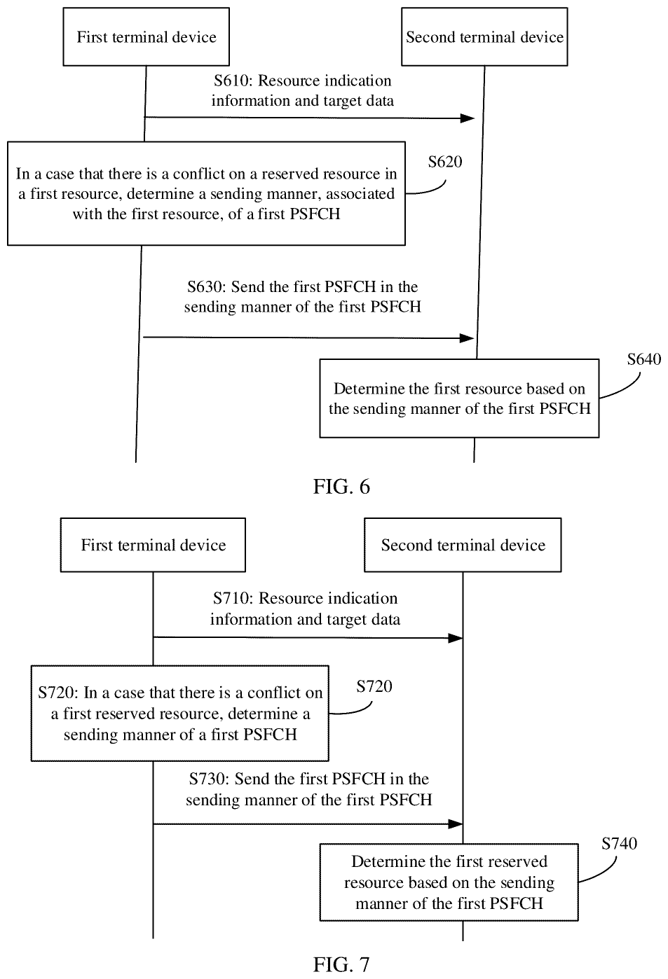

The following describes a communication method according to an embodiment of this application with reference to FIG. 6. FIG. 6 is a schematic flowchart of a communication method according to an embodiment of this application. The method shown in FIG. 6 includes step S610 to step S640.

In step S610, a second terminal device sends resource indication information and target data to a first terminal device.

The resource indication information is used to indicate a plurality of reserved resources reserved by the second terminal device.

In some implementations, the resource indication may be sent by the second terminal device by using SCI. For a specific sending manner, refer to the foregoing description of the SCI. For brevity, details are not described herein again.

In step S620, in a case that there is a conflict on a reserved resource in a first resource, the first terminal device determines, based on an association relationship between the reserved resource on which a conflict occurs and a sending manner of a PSFCH, a sending manner, associated with the reserved resource (also referred to as the “first resource”) on which a conflict occurs in the plurality of reserved resources, of a first PSFCH. The first resource may include one or more reserved resources on which a conflict occurs.

The associated sending manner of the PSFCH varies with the reserved resource on which a conflict occurs in the plurality of reserved resources. That the foregoing reserved resources on which a conflict occurs being different may include that the reserved resources on which a conflict occurs are completely different reserved resources. For example, if the reserved resource on which a conflict occurs is a reserved resource 1, a sending manner, associated with the reserved resource 1, of the PSFCH is a PSFCH sending manner 1; or if the reserved resource on which a conflict occurs is a reserved resource 2, a sending manner, associated with the reserved resource 2, of the PSFCH is a PSFCH sending manner 2, and the PSFCH sending manner 1 is different from the PSFCH sending manner 2. That the foregoing reserved resources on which a conflict occurs being different may include that the reserved resources on which a conflict occurs are not exactly the same reserved resources. For example, if the reserved resource on which a conflict occurs is a reserved resource 1, a sending manner, associated with the reserved resource 1, of the PSFCH is a PSFCH sending manner 1. If the reserved resource on which a conflict occurs includes a reserved resource 1 and a reserved resource 2, a sending manner, associated with the reserved resource 1 and the reserved resource 2, of the PSFCH is a PSFCH sending manner 3, and the PSFCH sending manner 1 is different from the PSFCH sending manner 3.

The foregoing sending manner of the first PSFCH may include sending or skipping sending the first PSFCH. In addition, in a case of sending the first PSFCH, the first PSFCH carries a first resource conflict indication and/or a HARQ feedback for the target data. The first resource conflict indication is used to indicate that there is a reserved resource on which a conflict occurs in the plurality of reserved resources. The HARQ feedback for the target data is used to indicate whether the first terminal device properly receives the target data.

The foregoing sending manner of the first resource conflict indication may include a sequence of sending the first resource conflict indication, a frequency-domain unit (such as a PRB) occupied by sending the first resource conflict indication, and the like. The foregoing sending manner of the HARQ feedback for the target data includes whether to carry the HARQ feedback in the first PSFCH, and/or whether the carried HARQ feedback is a NACK or an ACK. The following is described in detail with reference to specific cases. For brevity, details are not described herein.

In step S630, the first terminal device sends the first PSFCH to the second terminal device in the sending manner of the first PSFCH.

It should be noted that the foregoing first PSFCH may include a plurality of PSFCHs. In some cases described below (for example, cases 3 to 5 in Table 2; a case 5 in Table 3; and cases 1 to 3 and a manner 2 in a case 5 in Table 4), when the first terminal device needs to send both the first HARQ feedback and the first resource conflict indication, the first PSFCH may include two PSFCHs. In some other cases (for example, a case 5 in Table 5) described below, when the first terminal device needs to send the first resource conflict indication in both two frequency-domain units, the first PSFCH may include two PSFCHs.

The foregoing first PSFCH may alternatively include one PSFCH. In some scenarios described below (for example, cases 1 to 5 in Table 1; cases 1 and 2 in Table 2; cases 1 to 4 and a manner 2 in a case 5 in Table 3; cases 1 to 4 in Table 5; and cases 1 to 3 and 5 in Table 6), the first terminal device needs to feed back only the first resource conflict indication or the first HARQ feedback. In this case, the first PSFCH may include one PSFCH.

In step S640, the second terminal device determines the first resource based on the sending manner of the first PSFCH.

After determining the reserved resource on which a conflict occurs, the second terminal device may perform resource reselection according to a preset rule, and perform data transmission on a reselected sidelink resource. This is not specifically limited in this embodiment of this application. In some implementations, if the second terminal device determines the reserved resource on which a conflict occurs, the second terminal device may perform resource reselection based on the foregoing described sidelink resource selection manner. Correspondingly, if the reserved resource on which a conflict occurs is used for retransmission of current data (for example, a TB) (in other words, the reserved resource on which a conflict occurs is a retransmission resource), the second terminal device may retransmit the current data by using a reselected resource. If the reserved resource on which a conflict occurs is used for initial transmission of next data (in other words, the reserved resource on which a conflict occurs is an initial transmission resource), the second terminal device may send the new data by using a reselected resource.

As described above, to avoid directly carrying, in the resource conflict indication, an identifier of the reserved resource on which a conflict occurs, the reserved resource on which a conflict occurs may be distinguished by using the sending manner of the PSFCH. Each sending manner of the PSFCH corresponds to a combination of the sending manner of the resource conflict indication and the sending manner of the HARQ feedback that are described above. The following describes the communication method in an embodiment of this application by using examples of different combination manners.

In a combination manner 1, the sending manner of the resource conflict indication includes a sequence of sending a resource conflict indication, and the sending manner of the HARQ feedback includes whether to send a HARQ feedback. The combination manner 1 further includes two combination manners. The following provides descriptions separately with reference to a combination manner 1-1 and a combination manner 1-2.

In the combination manner 1-1, the sequence of the resource conflict indication varies with the reserved resource on which a conflict occurs in the plurality of reserved resources. In other words, different sequences may correspond to different reserved resources on which a conflict occurs. The reserved resource on which a conflict occurs may be a retransmission resource of the target data, or may be an initial transmission resource of new data. This is not limited in this embodiment of this application. The following provides descriptions by using an example in which the plurality of reserved resources include a first reserved resource and a second reserved resource.

In a case 1, if the first resource is the first reserved resource, the sending manner of the first PSFCH is sending the first resource conflict indication by using a first sequence and skipping sending the first HARQ feedback.

In a case 2, if the first resource is the second reserved resource, the sending manner of the first PSFCH is sending the first resource conflict indication by using a second sequence and skipping sending the first HARQ feedback.

In a case 3, if the first resource includes the first reserved resource and the second reserved resource, the sending manner of the first PSFCH is sending the first resource conflict indication by using a third sequence.

It should be noted that, in the foregoing cases 1 to 3, the first terminal device may send an ACK or a NACK in the first PSFCH in a conventional HARQ feedback manner based on whether the target data is received. Certainly, if it is expected to further reduce a quantity of bits occupied by the PSFCH, the second terminal device may further determine whether the HARQ feedback needs to be sent in the first PSFCH. In some implementations, if the reserved resource on which a conflict occurs is a retransmission resource and the first terminal device fails to receive the target data, in this case, the second terminal device cares more about a specific reserved resource on which a conflict occurs. Therefore, to reduce a resource occupied by the first PSFCH, the first terminal device may send only first conflict indication information to the second terminal device, and does not send the first HARQ feedback. For example, in the foregoing cases 1 to 3, if the first terminal device fails to receive the target data, the second terminal device may not send the first HARQ feedback to the first terminal device, that is, not send the NACK to the first terminal device. In some other implementations, if the first resource is a retransmission resource of the target data and the first terminal device succeeds in receiving the target data, that is, an objective of transmitting the target data is achieved, in this case, the second terminal device actually does not care much about whether there is a conflict on the retransmission resource (that is, the foregoing first resource) of the target data. Therefore, in this case, to reduce a resource occupied by the first PSFCH, the first terminal device may not send the first PSFCH to the second terminal device.

In addition, in a case that there is no conflict on the reserved resource, a HARQ feedback may be sent to the second terminal device in the conventional HARQ feedback manner by using the PSFCH. For brevity, details are not described below.

For ease of understanding, the following describes the communication method in an embodiment of this application with reference to Table 1 and Table 2 by using an example in which the reserved resource on which a conflict occurs is a retransmission resource. Table 1 shows an association relationship between the reserved resource on which a conflict occurs and the sending manner of the PSFCH in an embodiment of this application. Table 2 shows an association relationship between the reserved resource on which a conflict occurs and the sending manner of the PSFCH in another embodiment of this application.

It should be noted that, if the association relationship in Table 1 is applicable to a case in which the first terminal device is a target receiving terminal of the second terminal device, the association relationship in Table 2 is applicable to a case in which the first terminal device is a non-target receiving terminal of the second terminal device. Certainly, if the association relationship in Table 1 is applicable to a case in which the first terminal device is a non-target receiving terminal of the second terminal device, the association relationship in Table 2 is applicable to a case in which the first terminal device is a target receiving terminal of the second terminal device.

TABLE 1

| | HARQ | | | |
|---|---|---|---|---|
| | feedback | | | |
| | for the | Reserved | Reserved | |
| Case | target data | resource 1 | resource 2 | Sending manner of the first PSFCH |
| Case 1 | ACK | There is no | There is no | Send, in the first PSFCH, a sending |
| | | conflict | conflict | manner of a sending manner of the |
| | | | | first HARQ feedback in a |
| | | | | conventional HARQ feedback |
| Case 2 | NACK | There is no | There is no | Feed back only a NACK |
| | | conflict | conflict | |
| Case 3 | NACK | There is a | There is no | Sendthe first resource conflict |
| | | conflict | conflict | indication by using a first sequence |
| Case 4 | NACK | There is no | There is a | Send the first resource conflict |
| | | conflict | conflict | indication by using a second |
| | | | | sequence |
| Case 5 | NACK | There is a | There is a | Send the first resource conflict |
| | | conflict | conflict | indication by using a third sequence |

It is assumed that the reserved resource 1 and the reserved resource 2 that are reserved by the second terminal device are used for retransmission of the target data. With reference to Table 1, in the case 1, if the HARQ feedback for the target data is an ACK to the first terminal device, and there is no conflict on the reserved resource 1 and the reserved resource 2, the first terminal device may send, in the first PSFCH, a sending manner of the first HARQ feedback in the conventional HARQ feedback sending manner. In an implementation, if the first terminal device supports an ACK/NACK-based HARQ feedback, the first terminal device may send an ACK to the second terminal device by using the first PSFCH. In another implementation, if the first terminal device supports a NACK-only based HARQ feedback, the first terminal device may not send, in the first PSFCH, the first HARQ feedback, or may not send the first PSFCH.

In the case 2, if the HARQ feedback for the target data is a NACK to the first terminal device and there is no conflict on the reserved resource 1 and the reserved resource 2, the first terminal device may send the first PSFCH to the second terminal device, where the first PSFCH includes only the NACK.

In the case 3, if the HARQ feedback for the target data is a NACK to the first terminal device, there is a conflict on the reserved resource 1 (that is, the foregoing first resource is the reserved resource 1), and there is no conflict on the reserved resource 2, the first terminal device may send the first PSFCH to the second terminal device, where a sequence of the first resource conflict indication in the first PSFCH is the first sequence.

In the case 4, if the HARQ feedback for the target data is a NACK to the first terminal device, there is no conflict on the reserved resource 1, and there is a conflict on the reserved resource 2 (that is, the foregoing first resource is the reserved resource 2), the first terminal device may send the first PSFCH to the second terminal device, where a sequence of the first resource conflict indication in the first PSFCH is the second sequence.

In the case 5, if the HARQ feedback for the target data is a NACK to the first terminal device, and there is a conflict on each of the reserved resource 1 and the reserved resource 2 (that is, the foregoing first resource includes the reserved resource 1 and the reserved resource 2), the first terminal device may send the first PSFCH to the second terminal device, where a sequence of the first resource conflict indication in the first PSFCH is the third sequence.

In addition, as described above, if the first terminal device succeeds in receiving the target data, it indicates that the objective of transmitting the target data is achieved. In this case, if the reserved resource 1 and the reserved resource 2 are retransmission resources, the second terminal device actually does not care about whether there is a conflict on the foregoing retransmission resources. To reduce overheads occupied for transmitting the first PSFCH, the first terminal device may not send the first PSFCH to the second terminal device.

TABLE 2

| | HARQ | | | |
|---|---|---|---|---|
| | feedback | | | |
| | for the | Reserved | Reserved | |
| Case | target data | resource 1 | resource 2 | Sending manner of the first PSFCH |
| Case 1 | ACK | There is no | There is no | Send, in the first PSFCH, a sending |
| | | conflict | conflict | manner of the first HARQ feedback |
| | | | | in a conventional HARQ feedback |
| Case 2 | NACK | There is no | There is no | Feed back only an NACK |
| | | conflict | conflict | |
| Case 3 | NACK | There is a | There is no | Send the first resource conflict |
| | | conflict | conflict | indication by using a first sequence, |
| | | | | and feed back an NACK |
| Case 4 | NACK | There is no | There is a | Send the first resource conflict |
| | | conflict | conflict | indication by using a second |
| | | | | sequence, and feed back a NACK |
| Case 5 | NACK | There is a | There is a | Send the first resource conflict |
| | | conflict | conflict | indication by using a third sequence, |
| | | | | and feed back a NACK |

It is assumed that the reserved resource 1 and the reserved resource 2 that are reserved by the second terminal device are used for retransmission of the target data. With reference to Table 2, in the case 1, if the HARQ feedback for the target data is an ACK to the first terminal device, and there is no conflict on the reserved resource 1 and the reserved resource 2, the first terminal device may send, in the first PSFCH, a sending manner of the first HARQ feedback in the conventional HARQ feedback sending manner. In an implementation, if the first terminal device supports an ACK/NACK-based HARQ feedback, the first terminal device may send an ACK to the second terminal device by using the first PSFCH. In another implementation, if the first terminal device supports a NACK-only based HARQ feedback, the first terminal device may not send, in the first PSFCH, the first HARQ feedback, or may not send the first PSFCH.

In the case 2, if the HARQ feedback for the target data is a NACK to the first terminal device, and there is no conflict on the reserved resource 1 and the reserved resource 2, the first terminal device may send the first PSFCH to the second terminal device, where the first PSFCH includes only the NACK.

In the case 3, if the HARQ feedback for the target data is a NACK to the first terminal device, there is a conflict on the reserved resource 1 (that is, the foregoing first resource is the reserved resource 1), and there is no conflict on the reserved resource 2, the first terminal device may send the first PSFCH to the second terminal device, where the first PSFCH includes an NACK and the first resource conflict indication of the first sequence.

In the case 4, if the HARQ feedback for the target data is a NACK to the first terminal device, there is no conflict on the reserved resource 1, and there is a conflict on the reserved resource 2 (that is, the foregoing first resource is the reserved resource 2), the first terminal device may send the first PSFCH to the second terminal device, where the first PSFCH includes the NACK and the first resource conflict indication of the second sequence.

In the case 5, if the HARQ feedback for the target data is a NACK to the first terminal device, and there is a conflict on each of the reserved resource 1 and the reserved resource 2 (that is, the foregoing first resource includes the reserved resource 1 and the reserved resource 2), the first terminal device may send the first PSFCH to the second terminal device, where the first PSFCH includes the NACK and the first resource conflict indication of the third sequence.

It should be noted that in some scenarios, a terminal device may not support sending both a HARQ feedback and a resource conflict indication by using a PSFCH. In this case, because a solution of the resource conflict indication belongs to an enhanced solution, the second terminal device may send only the HARQ feedback by using the PSFCH. For example, in the association relationship shown in the foregoing Table 2, if the second terminal device does not support sending both the first HARQ feedback and the first resource conflict indication by using the first PSFCH, the second terminal device may send only the first HARQ feedback by using the first PSFCH.

In the combination manner 1-2, different cases in which there is a conflict on a reserved resource are associated with a plurality of cases of a combination of a sequence of a resource conflict indication and a sending manner of the HARQ feedback. The reserved resource on which a conflict occurs may be a retransmission resource of the target data, or may be an initial transmission resource of new data. This is not limited in this embodiment of this application. The following provides descriptions by using an example in which the plurality of reserved resources include a reserved resource 1 and a reserved resource 2.

In a case 1, if the first resource is the first reserved resource, the sending manner of the first PSFCH is sending the first resource conflict indication by using a first sequence and skipping sending the first HARQ feedback.

In a case 2, if the first resource is the second reserved resource, the sending manner of the first PSFCH is sending the first resource conflict indication by using a second sequence and skipping sending the first HARQ feedback.

In the foregoing cases 1 and 2, the first terminal device may send an ACK or a NACK in a conventional HARQ feedback manner based on whether the target data is received. Certainly, if it is expected to further reduce a quantity of bits occupied by the first PSFCH, the second terminal device may further determine whether the HARQ feedback needs to be sent in the first PSFCH. In some implementations, if the reserved resource on which a conflict occurs is a retransmission resource, and the first terminal device fails to receive the target data, in this case, the second terminal device cares more about a specific reserved resource on which a conflict occurs. Therefore, to reduce a resource occupied by the first PSFCH, the first terminal device may send only first conflict indication information to the second terminal device, and does not feed back the first HARQ feedback. For example, in the foregoing cases 1 and 2, if the first terminal device fails to receive the target data, the second terminal device may not send the first HARQ feedback to the first terminal device, that is, not send the NACK to the first terminal device. In some other implementations, if the first resource is a retransmission resource of the target data, and the first terminal device succeeds in receiving the target data, that is, an objective of transmitting the target data is achieved, in this case, the second terminal device actually does not care much about whether there is a conflict on the retransmission resource (that is, the foregoing first resource) of the target data. Therefore, in this case, to reduce a resource occupied by the first PSFCH, the first terminal device may not send the first PSFCH to the second terminal device.

In a case 3, if the first terminal device fails to receive the target data, and the first resource includes the first reserved resource and the second reserved resource, the sending manner of the resource conflict indication is sending the first resource conflict indication by using a first sequence, and the sending manner of the HARQ feedback is sending a HARQ feedback.

In some cases, if the first terminal device supports an ACK/NACK-based HARQ feedback, the first HARQ feedback fed back by the first terminal device is a NACK. In other words, the first terminal device may send the first PSFCH to the second terminal device, where the first PSFCH includes the first resource conflict indication of the first sequence and the NACK. In some other cases, if the first terminal device supports a NACK-only based HARQ feedback, the first terminal device needs to feed back the first resource conflict indication of the first sequence and the ACK to the second terminal device. In such NACK-only based HARQ feedback scenario, a receiving end of the target data (including a target receiving terminal and a non-target receiving terminal of the first terminal device) sends a NACK to the second terminal device by using a same sidelink resource. In addition, the second terminal device cannot distinguish which terminal device is a transmitting end of the NACK. In other words, once there is a terminal device failing to receive the target data, the terminal device sends a NACK to the second terminal device. In this case, after the second terminal device receives the resource conflict indication of the first sequence sent by the first terminal device (that is, the case 1 in the combination manner 1-2), the second terminal device cannot distinguish between the case 1 and the case 3. Therefore, to avoid this case, the first terminal device needs to be configured to send an ACK to the second terminal device even through the first terminal device fails to receive the target data in the case 3, to distinguish from the case 1 in the combination manner 1-2.

In addition, a sequence of the ACK is not specified in the NACK-only based HARQ feedback. In this case, the ACK may be directly fed back by using a sequence, indicated in the ACK/NACK-based HARQ feedback, of the ACK. Certainly, another sequence may be used to indicate the ACK. This is not limited in this embodiment of this application.

It should be noted that in a case that there is no conflict on the reserved resource, the first PSFCH may send the first PSFCH to the second terminal device in the conventional HARQ feedback manner. For brevity, details are not described below.

For ease of understanding, the following describes the communication method in an embodiment of this application with reference to Table 3 by using an example in which the reserved resource on which a conflict occurs is a retransmission resource. Table 3 shows an association relationship between the reserved resource on which a conflict occurs and the sending manner of the PSFCH in another embodiment of this application.

TABLE 3

| | HARQ | | | |
|---|---|---|---|---|
| | feedback | | | |
| | for the | Reserved | Reserved | |
| Case | target data | resource 1 | resource 2 | Sending manner of the first PSFCH |
| Case 1 | ACK | There is no | There is no | Send, in the first PSFCH, a sending |
| | | conflict | conflict | manner of the first HARQ feedback |
| | | | | in a conventional HARQ feedback |
| Case 2 | NACK | There is no | There is no | Feed back only an NACK |
| | | conflict | conflict | |
| Case 3 | NACK | There is a | There is no | Send the first resource conflict |
| | | conflict | conflict | indication by using a first sequence |
| Case 4 | NACK | There is no | There is a | Send the first resource conflict |
| | | conflict | conflict | indication by using a second |
| | | | | sequence |
| Case 5 | NACK | There is a | There is a | Send the first resource conflict |
| | | conflict | conflict | indication by using a first sequence |
| | | | | and a NACK in a case of an |
| | | | | ACK/NACK-based HARQ |
| | | | | feedback; and |
| | | | | send the first resource conflict |
| | | | | indication by using a first sequence |
| | | | | and an ACK in a case of a NACK- |
| | | | | only based HARQ feedback |

It is assumed that the reserved resource 1 and the reserved resource 2 that are reserved by the second terminal device are used for retransmission of the target data. With reference to Table 3, in the case 1, if the HARQ feedback for the target data is an ACK to the first terminal device, and there is no conflict on the reserved resource 1 and the reserved resource 2, the first terminal device may send, in the first PSFCH, a sending manner of the first HARQ feedback in the conventional HARQ feedback. In an implementation, if the first terminal device supports an ACK/NACK-based HARQ feedback, the first terminal device may send an ACK to the second terminal device by using the first PSFCH. In another implementation, if the first terminal device supports a NACK-only based HARQ feedback, the first terminal device may not send, in the first PSFCH, the first HARQ feedback, or may not send the first PSFCH.

In the case 2, if the HARQ feedback for the target data is a NACK to the first terminal device, and there is no conflict on the reserved resource 1 and the reserved resource 2, the first terminal device may send the first PSFCH to the second terminal device, where the first PSFCH includes only the NACK.

In the case 3, if the HARQ feedback for the target data is a NACK to the first terminal device, there is a conflict on the reserved resource 1 (that is, the foregoing first resource is the reserved resource 1), and there is no conflict on the reserved resource 2, the first terminal device may send the first PSFCH to the second terminal device, where a sequence of the first resource conflict indication in the first PSFCH is the first sequence.

In the case 4, if the HARQ feedback for the target data is a NACK to the first terminal device, there is no conflict on the reserved resource 1, and there is a conflict on the reserved resource 2 (that is, the foregoing first resource is the reserved resource 2), the first terminal device may send the first PSFCH to the second terminal device, where a sequence of the first resource conflict indication in the first PSFCH is the second sequence.

In the case 5, the HARQ feedback for the target data is a NACK to the first terminal device, and there is a conflict on each of the reserved resource 1 and the reserved resource 2 (that is, the foregoing first resource includes the reserved resource 1 and the reserved resource 2). In this case, in a scenario 1, if the first terminal device supports an ACK/NACK-based HARQ feedback, the HARQ feedback fed back by the first terminal device is a NACK. In other words, the first terminal device may send the first PSFCH to the second terminal device, where the first PSFCH includes the first resource conflict indication of the first sequence and the NACK. In a scenario 2, if the first terminal device supports a NACK-only based HARQ feedback, the first terminal device needs to feed back the first resource conflict indication of the first sequence and an ACK to the second terminal device. For a specific configuration reason, reference may be made to the foregoing descriptions. For brevity, details are not described herein again.

In addition, as described above, if the first terminal device succeeds in receiving the target data, it indicates that the objective of transmitting the target data is achieved. In this case, if the reserved resource 1 and the reserved resource 2 are retransmission resources, the second terminal device actually does not care about whether there is a conflict on the foregoing retransmission resources. To reduce overheads occupied for transmitting the first PSFCH, the first terminal device may not send the first PSFCH to the second terminal device.

It should be noted that the association relationship shown in Table 3 may be applied to the target receiving terminal of the second terminal device. In this case, for ease of differentiation, the non-target receiving terminal device of the second terminal device may use the association relationship shown in Table 2. Certainly, the target receiving terminal of the second terminal device may also use the association relationship shown in Table 2. In this case, the non-target receiving terminal of the second terminal device may use the association relationship shown in Table 3.

In addition, when the association relationship shown in Table 2 and the association relationship shown in Table 3 are cooperatively used, it may be learned that the first terminal device sends the first HARQ feedback and the first resource conflict indication to the second terminal device in some cases. For example, in the case 5 in Table 3 and the cases 3 to 5 in Table 2, to facilitate distinguishing, by the second terminal device, whether a transmitting end of the first PSFCH is a target receiving terminal or a non-target receiving terminal for determining whether the target data needs to be retransmitted, a sequence of the HARQ feedback may be configured to be the same as a sequence of the resource conflict indication when the target receiving terminal needs to transmit the HARQ feedback, and a sequence of the HARQ feedback may be configured to be different from a sequence of the resource conflict indication when the non-target receiving terminal transmits the HARQ feedback. Certainly, the foregoing configuration manners of the target receiving terminal and the non-target receiving terminal may be interchanged.

The foregoing describes that different sequences may be used to send the first resource conflict indication. In some implementations, the foregoing sequence may be generated in a cyclic shift manner. For example, the foregoing sequence may be determined based on a formula

$$α = \frac{2 π}{{N}_{s c}^{R B}} ( ( {m}_{0} + {m}_{c s} + {n}_{c s} ( {n}_{s , f}^{μ} , {l}^{′} ) ) mod {N}_{sc}^{R B} ) ,$$

where α represents a quantity of cyclic shifts, and N_{sc}^{RB} represents a quantity of subcarriers included in one RB. Usually, a value of N_{sc}^{RB} is 12; m₀ may be predefined according to a standard, or configured or preconfigured by a network; n_{cs}(n_{s,f}^{μ}, l′) represents a random number determined based on a sending slot and a sending symbol of a sequence of a conflict indication; and a value of m_{cs} is determined based on a sequence that needs to be generated. In other words, m_{cs} represents an identifier of a to-be-generated sequence. For example, if the to-be-generated sequence is the first sequence, the value of m_{cs} may be 0; if the to-be-generated sequence is the second sequence, the value of m_{cs} may be 1; or if the to-be-generated sequence is the third sequence, the value of m_{cs} may be 3. In addition, if three types of sequences are used in the association relationship between the sending manner of the PSFCH and the reserved resource on which a conflict occurs, correspondingly, a quantity of sequence pairs that allow code division multiplexing in one frequency-domain unit (for example, a PRB) configured in a PSFCH resource pool should not be less than 2.

According to a known transmission manner of a resource conflict indication, when there is a conflict on a reserved resource, a same reserved resource may be included in both the reserved resources, on which a conflict occurs, indicated by two resource conflict indications. For example, it is assumed that the reserved resource 1 is earlier than the reserved resource 2 in time domain, the reserved resource 2 is earlier than the reserved resource 3 in time domain, and there is a conflict on each of the reserved resource 1, the reserved resource 2, and the reserved resource 3. A resource conflict indication 1 indicates that the reserved resource on which a conflict occurs includes the reserved resource 1 and the reserved resource 2. A resource conflict indication 2 indicates that the reserved resource on which a conflict occurs includes the reserved resource 2 and the reserved resource 3. The reserved resource 2 is indicated twice respectively in the resource conflict indication 1 and the resource conflict indication 2. Therefore, to reduce a type of the sequence of the resource conflict indication, the resource conflict indication 1 may not indicate that there is a conflict on the reserved resource 2, because the resource conflict indication 2 indicates that there is a conflict on the reserved resource 2. That is, in a case that there is no conflict on the first reserved resource and there is a conflict on the second reserved resource, the first terminal device does not send the first PSFCH to the second terminal device, where the second reserved resource is later than the first reserved resource in time domain. In other words, in the case 4 shown in Table 1 to Table 3, the sending manner of the first PSFCH is skipping sending the first PSFCH.

For ease of understanding, with reference to Table 4, the following describes an association relationship between the sending manner of the PSFCH and the reserved resource on which a conflict occurs in another embodiment of this application by using an example in which the reserved resource on which a conflict occurs is a retransmission resource.

TABLE 4

| | HARQ | | | |
|---|---|---|---|---|
| | feedback | | | |
| | for the | Reserved | Reserved | |
| Case | target data | resource 1 | resource 2 | Sending manner of the first PSFCH |
| Case 1 | ACK | There is no | There is no | Send, in the first PSFCH, a sending |
| | | conflict | conflict | manner of the first HARQ feedback |
| | | | | in a conventional HARQ feedback |
| Case 2 | NACK | There is no | There is no | Feed back only a NACK |
| | | conflict | conflict | |
| Case 3 | NACK | There is a | There is no | Send the first resource conflict |
| | | conflict | conflict | indication by using a first sequence |
| Case 4 | NACK | There is no | There is a | Skip sending the first PSFCH |
| | | conflict | conflict | |
| Case 5 | NACK | There is a | There is a | Manner 1: send a first resource |
| | | conflict | conflict | conflict indication by using a first |
| | | | | sequence and a NACK in a case of |
| | | | | an ACK/NACK-based HARQ |
| | | | | feedback; and send a first resource |
| | | | | conflict indication by using a first |
| | | | | sequence and an ACK in a case of a |
| | | | | NACK-only based HARQ feedback |
| | | | | Manner 2: send a first resource |
| | | | | conflict indication by using a second |
| | | | | sequence |

It is assumed that the reserved resource 1 and the reserved resource 2 that are reserved by the second terminal device are used for retransmission of the target data. With reference to Table 4, in the case 1, if the HARQ feedback for the target data is an ACK to the first terminal device, and there is no conflict on the reserved resource 1 and the reserved resource 2, the first terminal device may send, in the first PSFCH, a sending manner of the first HARQ feedback in the conventional HARQ feedback. In an implementation, if the first terminal device supports an ACK/NACK-based HARQ feedback, the first terminal device may send an ACK to the second terminal device by using the first PSFCH. In another implementation, if the first terminal device supports a NACK-only based HARQ feedback, the first terminal device may not send, in the first PSFCH, the first HARQ feedback, or may not send the first PSFCH.

In the case 2, if the HARQ feedback for the target data is a NACK to the first terminal device, and there is no conflict on the reserved resource 1 and the reserved resource 2, the first terminal device may send the first PSFCH to the second terminal device, where the first PSFCH includes only the NACK.

In the case 3, if the HARQ feedback for the target data is a NACK to the first terminal device, there is a conflict on the reserved resource 1 (that is, the first resource is the reserved resource 1), and there is no conflict on the reserved resource 2, the first terminal device sends the first resource conflict indication by using the first sequence.

In the case 4, if the HARQ feedback for the target data is a NACK to the first terminal device, there is no conflict on the reserved resource 1, and there is a conflict on the reserved resource 2 (that is, the first resource is the reserved resource 2), the first terminal device does not need to send the first PSFCH.

In the case 5, the HARQ feedback for the target data is a NACK to the first terminal device, and there is a conflict on each of the reserved resource 1 and the reserved resource 2 (that is, the foregoing first resource includes the reserved resource 1 and the reserved resource 2). In this case, in the manner 1, if the first terminal device supports an ACK/NACK-based HARQ feedback, the HARQ feedback fed back by the first terminal device is a NACK. In other words, the first terminal device may send the first PSFCH to the second terminal device, where the first PSFCH includes the first resource conflict indication of the first sequence and a NACK. If the first terminal device supports a NACK-only based HARQ feedback, the first terminal device needs to feed back the first resource conflict indication of the first sequence and an ACK to the second terminal device. For a specific configuration reason, reference may be made to the foregoing descriptions. For brevity, details are not described herein again. In the manner 2, the first terminal device may send the resource conflict indication of the second sequence.

In a combination manner 2, the sending manner of the resource conflict indication includes a frequency-domain unit occupied by the resource conflict indication, and the sending manner of the HARQ feedback includes whether to send a HARQ feedback.

In an implementation, the frequency-domain unit occupied by the resource conflict indication varies with the reserved resource on which a conflict occurs in the plurality of reserved resources. In other words, different frequency-domain units may correspond to different reserved resources on which a conflict occurs. The reserved resource on which a conflict occurs may be a retransmission resource of the target data, or may be an initial transmission resource of new data. This is not limited in this embodiment of this application. The following provides descriptions by using an example in which the plurality of reserved resources include a first reserved resource and a second reserved resource.

In a case 1, if the first resource is the first reserved resource, the sending manner of the first PSFCH is sending the first resource conflict indication in a first frequency-domain unit.

In a case 2, if the first resource is the second reserved resource, the sending manner of the first PSFCH is sending the first resource conflict indication in a second frequency-domain unit.

In a case 3, if the first resource includes the first reserved resource and the second reserved resource, the sending manner of the first PSFCH is sending the first resource conflict indication in a first frequency-domain unit and a second frequency-domain unit.

It should be noted that, in the foregoing cases 1 to 3, the first terminal device may send an ACK or a NACK in a conventional HARQ feedback manner based on whether the target data is received. Certainly, if it is expected to further reduce a quantity of bits occupied by the PSFCH, the second terminal device may further determine whether the HARQ feedback needs to be sent in the PSFCH. In some implementations, if the reserved resource on which a conflict occurs is a retransmission resource, and the first terminal device fails to receive the target data, in this case, the second terminal device cares more about which reserved resource is the reserved resource on which a conflict occurs. Therefore, to reduce a resource occupied by the PSFCH, the first terminal device may send only the first conflict indication information to the second terminal device, but does not feed back the HARQ feedback. For example, in the foregoing cases 1 to 3, if the first terminal device fails to receive the target data, the second terminal device may not send the HARQ feedback to the first terminal device, that is, not send the NACK to the first terminal device. In some other implementations, if the first resource is a retransmission resource of the target data, and the first terminal device succeeds in receiving the target data, that is, an objective of transmitting the target data is achieved, in this case, the second terminal device actually does not care much about whether there is a conflict on the retransmission resource (that is, the foregoing first resource) of the target data. Therefore, in this case, to reduce a resource occupied by the PSFCH, the first terminal device may not send the first PSFCH to the second terminal device.

In addition, in a case that there is no conflict on the reserved resource, the first PSFCH may send the first PSFCH to the second terminal device in the conventional HARQ feedback manner. For brevity, details are not described below.

For ease of understanding, the following describes the communication method in another embodiment of this application with reference to Table 5 and Table 6 by using an example in which the reserved resource on which a conflict occurs is a retransmission resource. Table 5 shows an association relationship between the reserved resource on which a conflict occurs and the sending manner of the PSFCH in an embodiment of this application. Table 6 shows an association relationship between the reserved resource on which a conflict occurs and the sending manner of the PSFCH in another embodiment of this application.

It should be noted that, if the association relationship in Table 5 is applicable to a case in which the first terminal device is a target receiving terminal of the second terminal device, the association relationship in Table 6 is applicable to a case in which the first terminal device is a non-target receiving terminal of the second terminal device. Certainly, if the association relationship in Table 5 is applicable to a case in which the first terminal device is a non-target receiving terminal of the second terminal device, the association relationship in Table 6 is applicable to a case in which the first terminal device is a target receiving terminal of the second terminal device.

TABLE 5

| | HARQ | | | |
|---|---|---|---|---|
| | feedback | | | |
| | for the | Reserved | Reserved | |
| Case | target data | resource 1 | resource 2 | Sending manner of the first PSFCH |
| Case 1 | ACK | There is no | There is no | Send, in the first PSFCH, a sending |
| | | conflict | conflict | manner of the first HARQ feedback |
| | | | | in a conventional HARQ feedback |
| Case 2 | NACK | There is no | There is no | Feed back only a NACK |
| | | conflict | conflict | |
| Case 3 | NACK | There is a | There is no | Send the first resource conflict |
| | | conflict | conflict | indication in a first frequency- |
| | | | | domain unit |
| Case 4 | NACK | There is no | There is a | Send the first resource conflict |
| | | conflict | conflict | indication in a second frequency- |
| | | | | domain unit |
| Case 5 | NACK | There is a | There is a | Send the first resource conflict |
| | | conflict | conflict | indication in a first frequency- |
| | | | | domain unit and a second frequency- |
| | | | | domain unit |

It is assumed that the reserved resource 1 and the reserved resource 2 that are reserved by the second terminal device are used for retransmission of the target data. With reference to Table 5, in the case 1, if the HARQ feedback for the target data is an ACK to the first terminal device, and there is no conflict on the reserved resource 1 and the reserved resource 2, the first terminal device may send, in the first PSFCH, a sending manner of the first HARQ feedback in the conventional HARQ feedback. In an implementation, if the first terminal device supports an ACK/NACK-based HARQ feedback, the first terminal device may send an ACK to the second terminal device by using the first PSFCH. In another implementation, if the first terminal device supports a NACK-only based HARQ feedback, the first terminal device may not send, in the first PSFCH, the first HARQ feedback, or may not send the first PSFCH.

In the case 2, if the HARQ feedback for the target data is a NACK to the first terminal device, and there is no conflict on the reserved resource 1 and the reserved resource 2, the first terminal device may send the first PSFCH to the second terminal device, where the first PSFCH includes only the NACK.

In the case 3, if the HARQ feedback for the target data is a NACK to the first terminal device, there is a conflict on the reserved resource 1 (that is, the foregoing first resource is the reserved resource 1), and there is no conflict on the reserved resource 2, the first terminal device may send the first PSFCH to the second terminal device, where the first resource conflict indication in the first PSFCH occupies the first frequency-domain unit.

In the case 4, if the HARQ feedback for the target data is a NACK to the first terminal device, there is no conflict on the reserved resource 1, and there is a conflict on the reserved resource 2 (that is, the foregoing first resource is the reserved resource 2), the first terminal device may send the first PSFCH to the second terminal device, where the first resource conflict indication in the first PSFCH occupies the second frequency-domain unit.

In the case 5, if the HARQ feedback for the target data is a NACK to the first terminal device, there is a conflict on each of the reserved resource 1 and the reserved resource 2 (that is, the foregoing first resource includes the reserved resource 1 and the reserved resource 2), the first terminal device may send the first PSFCH to the second terminal device, where the first resource conflict indication in the first PSFCH occupies the first frequency-domain unit and the second frequency-domain unit.

In addition, as described above, if the first terminal device succeeds in receiving the target data, it indicates that the objective of transmitting the target data is achieved. In this case, if the reserved resource 1 and the reserved resource 2 are retransmission resources, the second terminal device actually does not care about whether there is a conflict on the foregoing retransmission resources. To reduce overheads occupied for transmitting the PSFCH, the first terminal device may not send the first PSFCH to the second terminal device.

As described above, according to a known transmission manner of a resource conflict indication, when there is a conflict on a reserved resource, a same reserved resource may be included in both the reserved resources, on which a conflict occurs, indicated by two resource conflict indications. For example, it is assumed that the reserved resource 1 is earlier than the reserved resource 2 in time domain, the reserved resource 2 is earlier than the reserved resource 3 in time domain, and there is a conflict on each of the reserved resource 1, the reserved resource 2, and the reserved resource 3. A resource conflict indication 1 indicates that the reserved resource on which a conflict occurs includes the reserved resource 1 and the reserved resource 2. A resource conflict indication 2 indicates that the reserved resource on which a conflict occurs includes the reserved resource 2 and the reserved resource 3. The reserved resource 2 is indicated twice respectively in the resource conflict indication 1 and the resource conflict indication 2. Therefore, to reduce a sidelink resource occupied by the resource conflict indication, the resource conflict indication 1 may not indicate that there is a conflict on the reserved resource 2, because the resource conflict indication 2 indicates that there is a conflict on the reserved resource 2. That is, in a case that there is no conflict on the first reserved resource and there is a conflict on the second reserved resource, the first terminal device does not send the first PSFCH to the second terminal device, where the second reserved resource is later than the first reserved resource in time domain. In other words, in the case 4 shown in Table 5, the sending manner of the first PSFCH is skipping sending the first PSFCH.

For ease of understanding, with reference to Table 6, the following describes an association relationship between the sending manner of the PSFCH and the reserved resource on which a conflict occurs in another embodiment of this application by using an example in which the reserved resource on which a conflict occurs is a retransmission resource.

TABLE 6

| | HARQ | | | |
|---|---|---|---|---|
| | feedback | | | |
| | for the | Reserved | Reserved | |
| Case | target data | resource 1 | resource 2 | Sending manner of the first PSFCH |
| Case 1 | ACK | There is no | There is no | Send, in the first PSFCH, a sending |
| | | conflict | conflict | manner of the first HARQ feedback |
| | | | | in a conventional HARQ feedback |
| Case 2 | NACK | There is no | There is no | Feed back only a NACK |
| | | conflict | conflict | |
| Case 3 | NACK | There is a | There is no | Send the first resource conflict |
| | | conflict | conflict | indication in a first frequency- |
| | | | | domain unit |
| Case 4 | NACK | There is no | There is a | Skip sending the first PSFCH |
| | | conflict | conflict | |
| Case 5 | NACK | There is a | There is a | Send the first resource conflict |
| | | conflict | conflict | indication in a second frequency- |
| | | | | domain unit |

It is assumed that the reserved resource 1 and the reserved resource 2 that are reserved by the second terminal device are used for retransmission of the target data. With reference to Table 6, in the case 1, if the HARQ feedback for the target data is an ACK to the first terminal device, and there is no conflict on the reserved resource 1 and the reserved resource 2, the first terminal device may send, in the first PSFCH, a sending manner of the first HARQ feedback in the conventional HARQ feedback. In an implementation, if the first terminal device supports an ACK/NACK-based HARQ feedback, the first terminal device may send an ACK to the second terminal device by using the first PSFCH. In another implementation, if the first terminal device supports a NACK-only based HARQ feedback, the first terminal device may not send, in the first PSFCH, the first HARQ feedback, or may not send the first PSFCH.

In the case 2, if the HARQ feedback for the target data is a NACK to the first terminal device, and there is no conflict on the reserved resource 1 and the reserved resource 2, the first terminal device may send the first PSFCH to the second terminal device, where the first PSFCH includes only the NACK.

In the case 3, if the HARQ feedback for the target data is a NACK to the first terminal device, there is a conflict on the reserved resource 1 (that is, the foregoing first resource is the reserved resource 1), and there is no conflict on the reserved resource 2, the first terminal device may send the first PSFCH to the second terminal device, where the first resource conflict indication in the first PSFCH occupies the first frequency-domain unit.

In the case 4, if the HARQ feedback for the target data is a NACK to the first terminal device, there is no conflict on the reserved resource 1, and there is a conflict on the reserved resource 2 (that is, the first resource is the reserved resource 2), the first terminal device may not send the first PSFCH to the second terminal device.

In the case 5, if the HARQ feedback for the target data is a NACK to the first terminal device, there is a conflict on each of the reserved resource 1 and the reserved resource 2 (that is, the foregoing first resource includes the reserved resource 1 and the reserved resource 2), the first terminal device may send the first PSFCH to the second terminal device, where the first resource conflict indication in the first PSFCH occupies the second frequency-domain unit.

In addition, as described above, if the first terminal device succeeds in receiving the target data, it indicates that the objective of transmitting the target data is achieved. In this case, if the reserved resource 1 and the reserved resource 2 are retransmission resources, the second terminal device actually does not care about whether there is a conflict on the foregoing retransmission resources. To reduce overheads occupied for transmitting the first PSFCH, the first terminal device may not send the first PSFCH to the second terminal device.

It should be noted that the method shown in the foregoing described combination manner 2 may be applied to the target receiving terminal of the second terminal device or the non-target receiving terminal of the second terminal device. This is not limited in this embodiment of this application. To help the second terminal device distinguish whether a transmitting end of the first PSFCH is a target receiving terminal or a non-target receiving terminal, the two types of terminal devices may be configured to send the first PSFCH on different frequency-domain units respectively. Certainly, if the target receiving terminal or the non-target receiving terminal does not need to be distinguished, the frequency-domain units may be not distinguished.

As described above, in the manner 2 of the enhanced resource allocation solution, when the terminal device 1 (also referred to as the “first terminal device”) detects that there is a conflict on the reserved resource of the terminal device 2 (also referred to as the “second terminal device”), the terminal device 1 may send a PSFCH (also referred to as the “first PSFCH”) to the terminal device 2 to carry the resource conflict indication. However, as described above, there is a small quantity of resources used to transmit the PSFCH. When the PSFCH is actually transmitted, the PSFCH usually occupies only one symbol in time domain and only one PRB in frequency domain. Therefore, a capacity of the PSFCH usually has only one bit. If the resource conflict indication directly carries an identifier of the reserved resource on which a conflict occurs, the resource used to transmit the PSFCH cannot carry both the resource conflict indication and the HARQ feedback.

Therefore, to reduce a quantity of bits occupied by the PSFCH, this application provides a communication method. A sending manner of a first PSFCH may be determined based on whether a reserved resource on which a conflict occurs is a retransmission resource or an initial transmission resource of target data. The communication method according to another embodiment of this application is described below with reference to FIG. 7.

FIG. 7 is a schematic flowchart of a communication method according to an embodiment of this application. The method shown in FIG. 7 includes step S710 to step S740.

In step S710, a second terminal device sends resource indication information and target data to a first terminal device.

The resource indication information is used to indicate a plurality of reserved resources reserved by the second terminal device. The plurality of reserved resources include a first reserved resource.

In step S720, in a case that there is a conflict on the first reserved resource, the first terminal device determines a sending manner of a first physical sidelink feedback channel PSFCH based on the first reserved resource being a retransmission resource or an initial transmission resource of the target data.

The sending manner of the first PSFCH includes sending the first PSFCH and skipping sending the first PSFCH. In addition, in a case of sending the first PSFCH, the sending manner of the first PSFCH further includes carrying, in the first PSFCH, a first HARQ feedback for the target data and/or a first resource conflict indication, and the first resource conflict indication is used to indicate that there is a conflict on the first reserved resource.

In some implementations, the foregoing first reserved resource may meet any one of the following conditions: The first reserved resource is a next sidelink resource that is reserved by the second terminal device by using the resource indication information and used for retransmission of the target data. The first reserved resource is a sidelink resource, in the plurality of reserved resources, that is closest to a time-domain unit occupied by the first resource indication information, in time domain. In this case, the first reserved resource may be a retransmission resource or an initial transmission resource of the target data. This is not limited in this embodiment of this application.

In step S730, the first terminal device sends the first PSFCH to the second terminal device in the sending manner of the first PSFCH.

It should be noted that the foregoing first PSFCH may include a plurality of PSFCHs. In some cases described below (for example, a manner 1 in a case 4 in Table 7; and a case 4 in Table 8), when the first terminal device needs to send both the first HARQ feedback and the first resource conflict indication, the first PSFCH may include two PSFCHs.

The foregoing first PSFCH may alternatively include one PSFCH. In some scenarios described below (for example, cases 1 to 3 in Table 7; and cases 1 and 3 in Table 8), the first terminal device needs to feed back only the first resource conflict indication or the first HARQ feedback. In this case, the first PSFCH may include one PSFCH.

In step S740, the second terminal device determines, based on the sending manner of the first PSFCH, a reserved resource on which a conflict occurs (that is, the first reserved resource).

After determining the reserved resource on which a conflict occurs, the second terminal device may perform resource reselection according to a preset rule, and perform data transmission on a reselected sidelink resource. This is not specifically limited in this embodiment of this application. If the second terminal device determines the reserved resource on which a conflict occurs, the second terminal device may perform resource reselection and data transmission with reference to a HARQ feedback of the first terminal device based on the foregoing described sidelink resource selection manner. In some implementations, if the first PSFCH carries the first resource conflict indication and the first HARQ feedback is an ACK, and the reserved resource on which a conflict occurs (that is, the first reserved resource) is a retransmission resource of the target data, the second terminal device may stop sending the target data. In some other implementations, if the first PSFCH carries the first resource conflict indication and the first HARQ feedback is a NACK, the second terminal device may perform resource reselection, and transmit the target data by using a reselected reserved resource. In some other implementations, if the first PSFCH carries the first resource conflict indication, and the reserved resource on which a conflict occurs is an initial transmission resource, regardless of whether the first terminal device succeeds in receiving the target data, the second terminal device performs resource reselection and sends new data by using a reselected sidelink resource.

Usually, if the reserved resource on which a conflict occurs is an initial transmission resource, it indicates that a transmission process of the target data ends. In this case, for the second terminal device, the second terminal device does not care about whether the first terminal device succeeds in receiving the target data. Therefore, to reduce a sidelink resource occupied by the first PSFCH, it may be configured that the first PSFCH sent by the second terminal to the first terminal device carry only the first resource conflict indication and does not carry the HARQ feedback.

In other words, in a case 1, if the first terminal device succeeds in receiving the target data and the first reserved resource is an initial transmission resource, the sending manner of the first PSFCH is carrying the first resource conflict indication in the first PSFCH.

In a case 2, if the first terminal device fails to receive the target data and the first reserved resource is an initial transmission resource, the sending manner of the first PSFCH is carrying the first resource conflict indication in the first PSFCH.

If the first terminal device fails to receive the target data and the reserved resource on which a conflict occurs is a retransmission resource of the target data, in this case, the second terminal device needs to determine, based on a result of receiving the target data by the first terminal device, whether to retransmit the target data. Therefore, in this case, the first terminal device needs to carry the first HARQ feedback and the first resource conflict indication in the first PSFCH.

That is, in a case 4, if the first terminal device fails to receive the target data and the first reserved resource is a retransmission resource, the sending manner of the first PSFCH is carrying, in the first PSFCH, the first resource conflict indication and the first HARQ feedback.

If the first terminal device succeeds in receiving the target data, the objective of transmitting the target data by the first terminal device is achieved. The second terminal device does not care about whether there is a conflict on a retransmission resource of the target data. In this case, to reduce the sidelink resource occupied by the first PSFCH, the first terminal device may not send the first PSFCH to the second terminal device.

For ease of understanding, with reference to Table 7 and Table 8, the following describes an association relationship between the sending manner of the PSFCH and the reserved resource on which a conflict occurs in an embodiment of this application by using an example in which the reserved resource on which a conflict occurs is a reserved resource 1.

It should be noted that, if the association relationship in Table 7 is applicable to a case in which the first terminal device is a target receiving terminal of the second terminal device, the association relationship in Table 8 is applicable to a case in which the first terminal device is a non-target receiving terminal of the second terminal device. Certainly, if the association relationship in Table 7 is applicable to a case in which the first terminal device is a non-target receiving terminal of the second terminal device, the association relationship in Table 8 is applicable to a case in which the first terminal device is a target receiving terminal of the second terminal device.

TABLE 7

| | HARQ | | |
|---|---|---|---|
| | feedback | | |
| | for the | Reserved | Sending manner of the first |
| Case | target data | resource 1 | PSFCH |
| Case | ACK | There is no | Send, in the first PSFCH, a sending |
| 1 | | conflict | manner of the first HARQ feedback |
| | | | in a conventional HARQ feedback |
| Case | ACK | Initial | Send the first resource conflict |
| 2 | | transmission | indication |
| | | resource with | |
| | | a conflict | |
| Case | NACK | There is no | Feed back only a NACK |
| 3 | | conflict | |
| Case | NACK | There is a | Manner 1, send, in the first PSFCH, |
| 4 | | conflict | the first resource conflict indication |
| | | | and a NACKif the reserved resource |
| | | | 1 is a retransmission resource |
| | | | Manner 2, send, in the first PSFCH, |
| | | | the first resource conflict indication |
| | | | if the reserved resource 1 is an initial |
| | | | transmission resource |

It is assumed that the reserved resource reserved by the second terminal device is the reserved resource 1. With reference to Table 7, in the case 1, if the HARQ feedback for the target data is an ACK to the first terminal device and there is no conflict on the reserved resource 1, the first terminal device may send, in the first PSFCH, a sending manner of the first HARQ feedback in the conventional HARQ feedback. In an implementation, if the first terminal device supports an ACK/NACK-based HARQ feedback, the first terminal device may send an ACK to the second terminal device by using the first PSFCH. In another implementation, if the first terminal device supports a NACK-only based HARQ feedback, the first terminal device may not send, in the first PSFCH, the first HARQ feedback, or may not send the first PSFCH.

In the case 2, if the HARQ feedback for the target data is a NACK to the first terminal device, the reserved resource 1 is an initial transmission resource, and there is a conflict on the reserved resource 1 (that is, the foregoing first reserved resource is the reserved resource 1), the first terminal device may send the first PSFCH to the second terminal device, where the first PSFCH carries only the first resource conflict indication, and the first resource conflict indication is used to indicate that there is a conflict on the reserved resource 1.

In the case 3, if the HARQ feedback for the target data is a NACK to the first terminal device and there is no conflict on the reserved resource 1, the first terminal device may send the first PSFCH to the second terminal device, where the first PSFCH carries only the NACK.

In the case 4, the HARQ feedback for the target data is a NACK to the first terminal device, and there is a conflict on the reserved resource 1 (that is, the first reserved resource is the reserved resource 1). In this case, in the manner 1, if the reserved resource 1 is a retransmission resource of the target data, the first PSFCH sent by the first terminal device to the second terminal device carries the first resource conflict indication and the NACK. In the manner 2, the first PSFCH sent by the first terminal device to the second terminal device carries only the first resource conflict indication if the reserved resource 1 is an initial transmission resource.

In addition, as described above, if the first terminal device succeeds in receiving the target data, it indicates that the objective of transmitting the target data is achieved. In this case, if the reserved resource 1 is a retransmission resource, the second terminal device actually does not care about whether there is a conflict on the foregoing retransmission resource. To reduce overheads occupied for transmitting the PSFCH, the first terminal device may not send the first PSFCH to the second terminal device.

TABLE 8

| | HARQ | | |
|---|---|---|---|
| | feedback | | |
| | for the | Reserved | Sending manner of the first |
| Case | target data | resource 1 | PSFCH |
| Case | ACK | There is no | Send, in the first PSFCH, a sending |
| 1 | | conflict | manner of the first PSFCH in a |
| | | | conventional HARQ feedback |
| Case | ACK | Initial | Send the first resource conflict |
| 2 | | transmission | indication |
| | | resource with | |
| | | a conflict | |
| Case | NACK | There is no | Feed back only a NACK |
| 3 | | conflict | |
| Case | NACK | There is a | Send the first resource conflict |
| 4 | | conflict | indication and a NACK |

It is assumed that the reserved resource reserved by the second terminal device is the reserved resource 1. With reference to Table 7, in the case 1, if the HARQ feedback for the target data is an ACK to the first terminal device and there is no conflict on the reserved resource 1, the first terminal device may send, in the first PSFCH, a sending manner of the first HARQ feedback in the conventional HARQ feedback. In an implementation, if the first terminal device supports an ACK/NACK-based HARQ feedback, the first terminal device may send an ACK to the second terminal device by using the first PSFCH. In another implementation, if the first terminal device supports a NACK-only based HARQ feedback, the first terminal device may not send, in the first PSFCH, the first HARQ feedback, or may not send the first PSFCH.

In the case 2, if the HARQ feedback for the target data is a NACK to the first terminal device, the reserved resource 1 is an initial transmission resource, and there is a conflict on the reserved resource 1, the first terminal device may send the first PSFCH to the second terminal device, where the first PSFCH carries only the first resource conflict indication, and the first resource conflict indication is used to indicate that there is a conflict on the reserved resource 1.

In the case 3, if the HARQ feedback for the target data is a NACK to the first terminal device, and there is no conflict on the reserved resource 1, the first terminal device may send the first PSFCH to the second terminal device, where the first PSFCH carries only a NACK.

In the case 4, the HARQ feedback for the target data is a NACK to the first terminal device, and there is a conflict on the reserved resource 1 (that is, the first reserved resource is the reserved resource 1). In this case, regardless of whether the reserved resource 1 is a retransmission resource or an initial transmission resource of the target data, the first PSFCH sent by the first terminal device to the second terminal device carries the first resource conflict indication and the NACK.

It should be noted that if the second terminal device does not support feeding back both the first resource conflict indication and the first HARQ (for example, a NACK) in the first PSFCH, the second terminal device may be configured to carry only the first HARQ feedback in the first PSFCH.

In addition, as described above, if the first terminal device succeeds in receiving the target data, it indicates that the objective of transmitting the target data is achieved. In this case, if the reserved resource 1 is a retransmission resource, the second terminal device actually does not care about whether there is a conflict on the foregoing retransmission resource. To reduce overheads occupied for transmitting the first PSFCH, the first terminal device may not send the first PSFCH to the second terminal device.

As described above, in the manner 2 of the enhanced resource allocation solution, when the terminal device 1 (also referred to as the “first terminal device”) detects that there is a conflict on the reserved resource of the terminal device 2 (also referred to as the “second terminal device”), the terminal device 1 may send a PSFCH to the terminal device 2 to carry the resource conflict indication. However, if a time-domain unit occupied by the PSFCH is relatively close to a time-domain unit occupied by the resource indication information, the first terminal device may not have enough time to decode the resource indication information, that is, the reserved resource of the second terminal device cannot be determined, and therefore it cannot be determined whether there is a conflict on the reserved resource. In addition, if the time-domain unit occupied by the PSFCH is relatively close to a time-domain unit in which the reserved resource is located, the second terminal device may not have enough time to decode the resource conflict indication, and therefore it cannot be determined whether there is a conflict on the reserved resource.

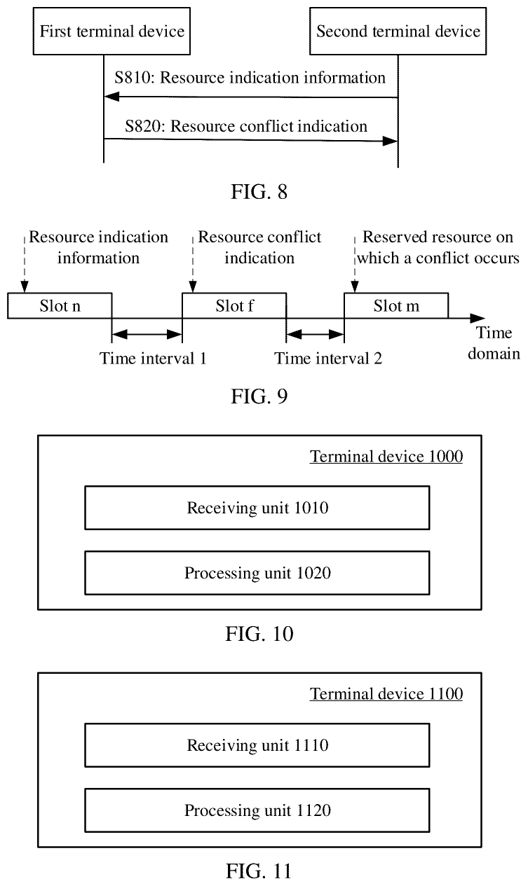

Therefore, to avoid the foregoing problem, an embodiment of this application further provides a communication method, to appropriately plan a time-domain location relationship among a time-domain unit occupied by resource indication information, a time-domain unit occupied by a resource conflict indication, and a time-domain unit in which a reserved resource is located. A procedure of the communication method according to an embodiment of this application is described below with reference to FIG. 8. The method shown in FIG. 8 includes step S810 and step S820. It should be noted that the communication method shown in FIG. 8 may be used in combination with any one of the communication methods described above. For brevity, details are not described again below.

In step S810, a second terminal device sends, in a first time-domain unit, resource indication information to a first terminal device.

The resource indication information is used to indicate one or more reserved resources, in a second time-domain unit, of the second terminal device. In some implementations, the foregoing resource indication information may be sent by using SCI. In some other implementations, the foregoing resource indication information may be the first resource indication information described in FIG. 6 and FIG. 7.

In step S820, the first terminal device sends, in a third time-domain unit, a resource conflict indication to the second terminal device.

The foregoing resource conflict indication is used to indicate that there is a reserved resource on which a conflict occurs in the plurality of reserved resources. In some implementations, the foregoing resource conflict indication may be sent by using a PSFCH. In some other implementations, the foregoing resource indication information may be the first resource conflict indication described in FIG. 6 and FIG. 7.

A location of the third time-domain unit in time domain is determined based on one or more of the following information: a location of the first time-domain unit in time domain; a location of the second time-domain unit in time domain; a time required for decoding the resource indication information by the first terminal device; a time required for preparing the resource conflict indication by the first terminal device; a time required for decoding the resource conflict indication by the second terminal device; and a time required for preparing, by the second terminal device, to transmit data on the reserved resource.

In some implementations, an interval between the third time-domain unit and the first time-domain unit in time domain may be determined based on the time required for preparing the resource conflict indication by the first terminal device and the time required for decoding the resource indication information by the first terminal device. For example, the interval between the third time-domain unit and the first time-domain unit in time domain is not less than (greater than or equal to) a sum of the time required for preparing the resource conflict indication by the first terminal device and the time required for decoding the resource indication information by the first terminal device.

In some other implementations, an interval between the third time-domain unit and the second time-domain unit in time domain may be determined based on the time required for decoding the resource conflict indication by the second terminal device and the time required for preparing, by the second terminal device, to transmit the data on the reserved resource. For example, the interval between the third time-domain unit and the second time-domain unit in time domain is not less than (or greater than or equal to) a sum of the time required for decoding the resource conflict indication by the second terminal device and the time required for preparing, by the second terminal device, to transmit the data on the reserved resource.

It should be noted that the time interval between the foregoing two time-domain units may be a time interval between middle locations of the two time-domain units, or may be a time interval between an end location of a 1st time-domain unit and a start location of a 2nd time-domain unit. This is not limited in this embodiment of this application. For example, the interval between the third time-domain unit and the first time-domain unit in time domain may be a time interval between an end location of the first time-domain unit and a start location of the third time-domain unit. The interval between the third time-domain unit and the second time-domain unit in time domain may be a time interval between an end location of the third time-domain unit and a start location of the second time-domain unit.

In some implementations, to simplify calculation of the time required for decoding the first PSFCH by the second terminal device, the time required for decoding the first PSFCH may be determined based on a time, specified in a current protocol, required for decoding sidelink control information SCI by the second terminal device.

To reduce overheads occupied for transmitting the resource conflict indication, the reserved resource, indicated by the foregoing resource conflict indication information, on which a conflict occurs may be determined according to a preset rule, or certainly may be specified by a network device. This is not limited in this embodiment of this application. In some implementations, the reserved resource on which a conflict occurs may meet any one of the following conditions: that at least some reserved resources of the plurality of reserved resources are initial transmission resources; that at least some reserved resources of the plurality of reserved resources are retransmission resources; and that the plurality of reserved resources belong to a resource set that is reserved by the second terminal device and indicated by the resource indication information, a distance between each of the plurality of reserved resources and a time-frequency resource occupied by the resource indication information is less than a first distance, and the first distance is a distance between another reserved resource in the resource set except the plurality of reserved resources and the time-frequency resource occupied by the resource indication information.

It should be noted that the foregoing first time-domain unit, second time-domain unit, and third time-domain unit each may be any unit in time domain, for example, may be a slot, a subframe, a symbol, or the like.

For ease of understanding, with reference to FIG. 9, the following describes the communication method in this embodiment of this application by using an example in which the time-domain units are slots. With reference to FIG. 9, it is assumed that the first time-domain unit occupied by the resource indication information is a slot n, the third time-domain unit occupied by the resource conflict indication is a slot m, and the second time-domain unit occupied by the reserved resource on which a conflict occurs is a slot f. In addition, the slot n is earlier than the slot f in time domain, and the slot f is earlier than the slot m in time domain. In this case, the foregoing described intervals between the three in time domain are as follows: An interval between an end location of the slot n and a start location of the slot f is greater than or equal to a time interval 1, where a time length of the time interval 1 is the sum of the time required for preparing the resource conflict indication by the first terminal device and the time required for decoding the resource indication information by the first terminal device. An interval between an end location of the slot f and a start location of the slot m is greater than or equal to a time interval 2, where a time length of the time interval 2 is the sum of the time required for decoding the resource conflict indication by the second terminal device and the time required for preparing, by the second terminal device, to transmit the data on the reserved resource.

The foregoing describes method embodiments of this application in detail with reference to FIG. 1 to FIG. 9. The following describes apparatus embodiments of this application in detail with reference to FIG. 10 to FIG. 16. It should be understood that the descriptions of the method embodiments correspond to descriptions of the apparatus embodiments. Therefore, for parts that are not described in detail, reference may be made to the foregoing method embodiments.

FIG. 10 is a schematic diagram of a terminal device according to an embodiment of this application. The terminal device shown in FIG. 10 may implement corresponding functions of the foregoing first terminal device. The terminal device 1000 shown in FIG. 10 includes a receiving unit 1010 and a processing unit 1020.

The receiving unit 1010 is configured to receive resource indication information and target data. The resource indication information is used to indicate a plurality of reserved resources reserved by a second terminal device. A part of or all of the plurality of reserved resources belong to a first resource.

The processing unit 1020 is configured to: in a case that there is a conflict on a reserved resource in the first resource, determine, based on an association relationship between the reserved resource on which a conflict occurs and a sending manner of a physical sidelink feedback channel PSFCH, a sending manner, associated with the first resource, of a first PSFCH. The first PSFCH carries a first HARQ feedback for the target data and/or a first resource conflict indication. The first resource conflict indication is used to indicate that there is a conflict on a reserved resource in the first resource. The sending manner of the PSFCH includes a sequence of a resource conflict indication that is used to indicate that there is a reserved resource on which a conflict occurs, and/or sending or skipping sending a HARQ feedback.

In a possible implementation, in a case that the first PSFCH carries the first HARQ feedback, the sequence that carries the resource conflict indication is the same as a sequence that carries the first HARQ feedback.

In a possible implementation, if the first terminal device fails to receive the target data and the first resource is a first reserved resource, the sending manner of the first PSFCH is sending the first resource conflict indication by using a first sequence and skipping sending the first HARQ feedback.

In a possible implementation, if the first terminal device fails to receive the target data and the first resource is a second reserved resource, the sending manner of the first PSFCH is sending the first resource conflict indication by using a second sequence and skipping sending the first HARQ feedback, where the second sequence is different from the first sequence.

In a possible implementation, the sequence of the resource conflict indication varies with the reserved resource on which a conflict occurs in the plurality of reserved resources.

In a possible implementation, if the first terminal device fails to receive the target data and the first resource includes the first reserved resource and the second reserved resource, the sending manner of the first PSFCH is sending the first resource conflict indication by using a third sequence.

In a possible implementation, if the first terminal device fails to receive the target data and the first resource includes the first reserved resource and the second reserved resource, the sending manner of the first PSFCH is sending the first resource conflict indication by using the first sequence and sending the first HARQ feedback.

In a possible implementation, the first HARQ feedback is a HARQ feedback based on only a NACK, and the first HARQ feedback is an ACK.

In a possible implementation, a reserved resource in the first resource is a retransmission resource of the target data.

FIG. 11 is a schematic diagram of a terminal device according to an embodiment of this application. The terminal device shown in FIG. 11 may implement corresponding functions of the foregoing first terminal device. The terminal device 1100 shown in FIG. 11 includes a receiving unit 1110 and a processing unit 1120.

The receiving unit 1110 is configured to receive resource indication information and target data. The resource indication information is used to indicate a plurality of reserved resources reserved by a second terminal device. A part of or all of the plurality of reserved resources belong to a first resource.

The processing unit 1120 is configured to: in a case that there is a conflict on a reserved resource in the first resource, determine, based on an association relationship between the reserved resource on which a conflict occurs and a sending manner of a physical sidelink feedback channel PSFCH, a sending manner, associated with the first resource, of a first PSFCH. The first PSFCH carries a first HARQ feedback for the target data and/or a first resource conflict indication. The first resource conflict indication is used to indicate that there is a conflict on the reserved resource in the first resource. The sending manner of the PSFCH includes a frequency-domain unit occupied by a conflict indication that is used to indicate that there is a reserved resource on which a conflict occurs, and/or sending or skipping sending a HARQ feedback.

In a possible implementation, the frequency-domain unit occupied by the resource conflict indication varies with the reserved resource on which a conflict occurs in the plurality of reserved resources.

In a possible implementation, if the first terminal device fails to receive the target data and the first resource is a first reserved resource, the sending manner of the first PSFCH includes occupying a first frequency-domain unit by the first resource conflict indication.

In a possible implementation, if the first terminal device fails to receive the target data and the first resource is a second reserved resource, the sending manner of the first PSFCH includes occupying a second frequency-domain unit by the first resource conflict indication.

In a possible implementation, if the first terminal device fails to receive the target data and the first resource includes a first reserved resource and a second reserved resource, the sending manner of the first PSFCH includes sending the first resource conflict indication by occupying a first frequency-domain unit and a second frequency-domain unit.

In a possible implementation, the sending manner of the first PSFCH further includes skipping sending the first HARQ feedback for the target data.

In a possible implementation, a reserved resource in the first resource is a retransmission resource of the target data.

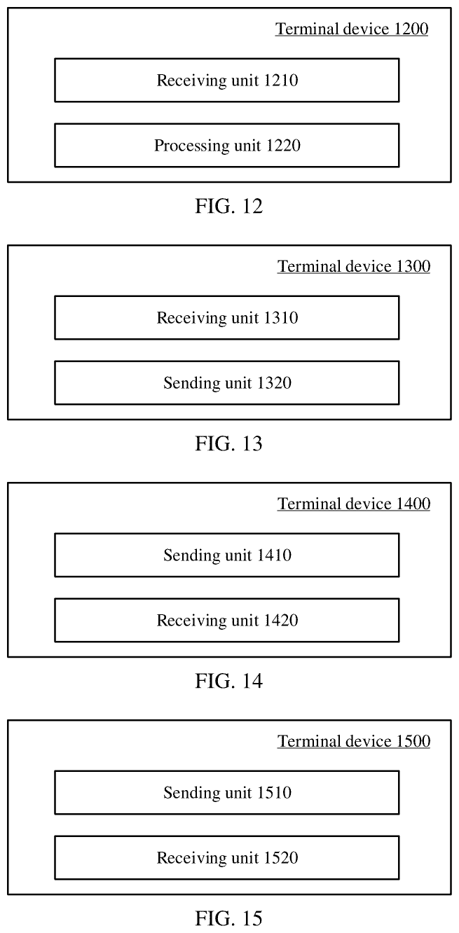

FIG. 12 is a schematic diagram of a terminal device according to an embodiment of this application. The terminal device shown in FIG. 12 may implement corresponding functions of the foregoing first terminal device. The terminal device 1200 shown in FIG. 12 includes a receiving unit 1210 and a processing unit 1220.

The receiving unit 1210 is configured to receive resource indication information and target data. The resource indication information is used to indicate a plurality of reserved resources reserved by a second terminal device. The plurality of reserved resources include a first reserved resource.

The processing unit 1220 is configured to: in a case that there is a conflict on the first reserved resource, determine a sending manner of a first physical sidelink feedback channel PSFCH based on the first reserved resource being a retransmission resource or an initial transmission resource of the target data. The sending manner of the first PSFCH includes carrying, in the first PSFCH, a first HARQ feedback for the target data and/or a first resource conflict indication. The first resource conflict indication is used to indicate that there is a conflict on the first reserved resource.

In a possible implementation, if the first terminal device succeeds in receiving the target data and the first reserved resource is the initial transmission resource, the sending manner of the first PSFCH is carrying the first resource conflict indication in the first PSFCH.

In a possible implementation, if the first terminal device fails to receive the target data and the first reserved resource is the initial transmission resource, the sending manner of the first PSFCH is carrying the first resource conflict indication in the first PSFCH.

In a possible implementation, if the first terminal device fails to receive the target data and the first reserved resource is the retransmission resource, the sending manner of the first PSFCH is carrying, in the first PSFCH, the first resource conflict indication and the first HARQ feedback.

FIG. 13 is a schematic diagram of a terminal device according to an embodiment of this application. The terminal device shown in FIG. 13 may implement corresponding functions of the foregoing first terminal device. The terminal device 1300 shown in FIG. 13 includes a receiving unit 1310 and a sending unit 1320.

The receiving unit 1310 is configured to receive, in a first time-domain unit, resource indication information sent by a second terminal device. The resource indication information is used to indicate a target reserved resource, in a second time-domain unit, of the second terminal device.

The sending unit 1320 is configured to send a resource conflict indication to the second terminal device in a third time-domain unit. The resource conflict indication is used to indicate that there is a reserved resource on which a conflict occurs in the target reserved resource. A location of the third time-domain unit in time domain is determined based on one or more of the following information: a location of the first time-domain unit in time domain; a location of the second time-domain unit in time domain; a time required for decoding the indication information by the first terminal device; a time required for preparing the resource conflict indication by the first terminal device; a time required for decoding the resource conflict indication by the second terminal device; and a time required for preparing, by the second terminal device, to transmit data on the reserved resource.

In a possible implementation, a time interval between the first time-domain unit and the third time-domain unit is determined based on the time required for decoding the indication information by the first terminal device and the time required for preparing the resource conflict indication by the first terminal device.

In a possible implementation, a time interval between the third time-domain unit and the second time-domain unit is determined based on the time required for decoding the resource conflict indication by the second terminal device and the time required for preparing, by the second terminal device, to transmit the data on the reserved resource.

In a possible implementation, the resource conflict indication is carried in a physical sidelink feedback channel PSFCH.

In a possible implementation, a time required for decoding the first PSFCH by the second terminal device is determined based on a time required for decoding sidelink control information SCI by the second terminal device.

In a possible implementation, the reserved resource on which a conflict occurs includes a plurality of reserved resources, and the plurality of reserved resources meet any one of the following conditions: that at least a part of the plurality of reserved resources in an initial transmission resource; that at least a part of the plurality of reserved resources is a retransmission resource; and that the plurality of reserved resources belong to a resource set that is reserved by the second terminal device and indicated by the resource indication information, a distance between each of the plurality of reserved resources and a time-frequency resource occupied by the resource indication information is less than a first distance, and the first distance is a distance between another reserved resource in the resource set except the plurality of reserved resources and the time-frequency resource occupied by the resource indication information.

FIG. 14 is a schematic diagram of a terminal device according to an embodiment of this application. The terminal device shown in FIG. 14 may implement corresponding functions of the foregoing second terminal device. The terminal device 1400 shown in FIG. 14 includes a sending unit 1410 and a receiving unit 1420.

The sending unit 1410 is configured to send resource indication information and target data to a first terminal device. The resource indication information is used to indicate a plurality of reserved resources reserved by the second terminal device. A part of or all of the plurality of reserved resources belong to a first resource.

The receiving unit 1420 is configured to: in a case that there is a conflict on a reserved resource in the first resource, receive a first physical sidelink feedback channel PSFCH sent by the first terminal device. A sending manner of the first PSFCH is determined based on the first resource, and an association relationship between the reserved resource on which a conflict occurs and a sending manner of a physical sidelink feedback channel PSFCH. The first PSFCH carries a first HARQ feedback for the target data and/or a first resource conflict indication. The first resource conflict indication is used to indicate that there is a conflict on the reserved resource in the first resource. The sending manner of the PSFCH includes a sequence of a resource conflict indication that is used to indicate that there is a reserved resource on which a conflict occurs, and/or sending or skipping sending a HARQ feedback.

In a possible implementation, in a case that the first PSFCH carries the first HARQ feedback, the sequence that carries the resource conflict indication is the same as a sequence that carries the first HARQ feedback.

In a possible implementation, if the first terminal device fails to receive the target data and the first resource is a first reserved resource, the sending manner of the first PSFCH is sending the first resource conflict indication by using a first sequence and skipping sending the first HARQ feedback.

In a possible implementation, if the first terminal device fails to receive the target data and the first resource is a second reserved resource, the sending manner of the first PSFCH is sending the first resource conflict indication by using a second sequence and skipping sending the first HARQ feedback, where the second sequence is different from the first sequence. In a possible implementation, the sequence of the resource conflict indication varies with the reserved resource on which a conflict occurs in the plurality of reserved resources.

In a possible implementation, if the first terminal device fails to receive the target data and the first resource includes the first reserved resource and the second reserved resource, the sending manner of the first PSFCH is sending the first resource conflict indication by using a third sequence.

In a possible implementation, if the first terminal device fails to receive the target data and the first resource includes the first reserved resource and the second reserved resource, the sending manner of the first PSFCH is sending the first resource conflict indication by using the first sequence and sending the first HARQ feedback.

In a possible implementation, the first HARQ feedback is a HARQ feedback based on only a NACK, and the first HARQ feedback is an ACK.

In a possible implementation, a reserved resource in the first resource is a retransmission resource of the target data.

FIG. 15 is a schematic diagram of a terminal device according to an embodiment of this application. The terminal device shown in FIG. 15 may implement corresponding functions of the foregoing second terminal device. The terminal device 1500 shown in FIG. 15 includes a sending unit 1510 and a receiving unit 1520.

The sending unit 1510 is configured to send resource indication information and target data to a first terminal device. The resource indication information is used to indicate a plurality of reserved resources reserved by the second terminal device. A part of or all of the plurality of reserved resources belong to a first resource.

The receiving unit 1520 is configured to: in a case that there is a conflict on a reserved resource in the first resource, receive a first physical sidelink feedback channel PSFCH. A sending manner of the first PSFCH is determined based on the first resource, and an association relationship between the reserved resource on which a conflict occurs and the sending manner of the PSFCH. The first PSFCH carries a first HARQ feedback for the target data and/or a first resource conflict indication. The first resource conflict indication is used to indicate that there is a conflict on the reserved resource in the first resource. The sending manner of the PSFCH includes a frequency-domain unit occupied by a conflict indication that is used to indicate that there is a reserved resource on which a conflict occurs, and/or sending or skipping sending a HARQ feedback.

In a possible implementation, the frequency-domain unit occupied by the resource conflict indication varies with the reserved resource on which a conflict occurs in the plurality of reserved resources.

In a possible implementation, if the first terminal device fails to receive the target data and the first resource is a first reserved resource, the sending manner of the first PSFCH includes occupying a first frequency-domain unit by the first resource conflict indication.

In a possible implementation, if the first terminal device fails to receive the target data and the first resource is a second reserved resource, the sending manner of the first PSFCH includes occupying a second frequency-domain unit by the first resource conflict indication.

In a possible implementation, if the first terminal device fails to receive the target data and the first resource includes a first reserved resource and a second reserved resource, the sending manner of the first PSFCH includes sending the first resource conflict indication by occupying a first frequency-domain unit and a second frequency-domain unit.

In a possible implementation, the sending manner of the first PSFCH further includes skipping sending the first HARQ feedback for the target data.

In a possible implementation, a reserved resource in the first resource is a retransmission resource of the target data.

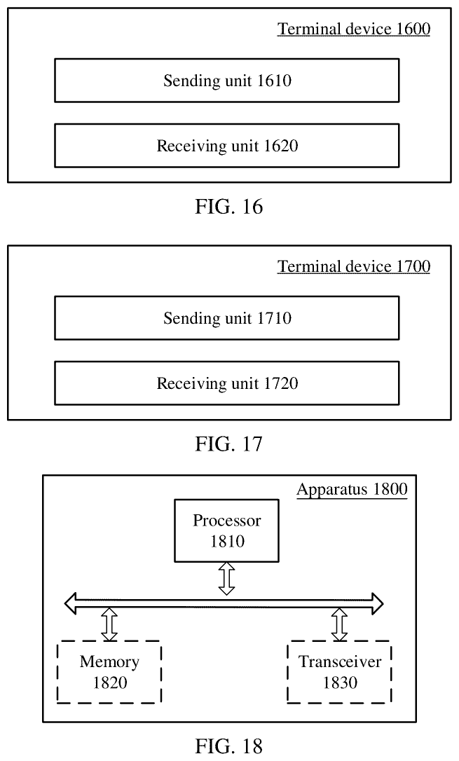

FIG. 16 is a schematic diagram of a terminal device according to an embodiment of this application. The terminal device shown in FIG. 16 may implement corresponding functions of the foregoing second terminal device. The terminal device 1600 shown in FIG. 16 may include a sending unit 1610 and a receiving unit 1620.

The sending unit 1610 is configured to send resource indication information and target data to a first terminal device. The resource indication information is used to indicate a plurality of reserved resources reserved by the second terminal device. The plurality of reserved resources include a first reserved resource.

The receiving unit 1620 is configured to: in a case that there is a conflict on the first reserved resource, receive a first physical sidelink feedback channel PSFCH sent by the first terminal device. The sending manner of the first PSFCH is determined based on the first reserved resource being a retransmission resource or an initial transmission resource of the target data. The sending manner of the first PSFCH includes carrying, in the first PSFCH, a first HARQ feedback for the target data and/or a first resource conflict indication. The first resource conflict indication is used to indicate that there is a conflict on the first reserved resource.

In a possible implementation, if the first terminal device succeeds in receiving the target data and the first reserved resource is the initial transmission resource, the sending manner of the first PSFCH is carrying the first resource conflict indication in the first PSFCH.

In a possible implementation, if the first terminal device fails to receive the target data and the first reserved resource is the initial transmission resource, the sending manner of the first PSFCH is carrying the first resource conflict indication in the first PSFCH.

In a possible implementation, if the first terminal device fails to receive the target data and the first reserved resource is the retransmission resource, the sending manner of the first PSFCH is carrying, in the first PSFCH, the first resource conflict indication and the first HARQ feedback.

FIG. 17 is a schematic diagram of a terminal device according to an embodiment of this application. The terminal device shown in FIG. 17 can implement corresponding functions of the foregoing second terminal device. The terminal device 1700 shown in FIG. 17 includes a sending unit 1710 and a receiving unit 1720.

The sending unit 1710 is configured to send, in a first time-domain unit, resource indication information to a first terminal device. The resource indication information is used to indicate a target reserved resource, in a second time-domain unit, of the second terminal device.

The receiving unit 1720 is configured to receive, in a third time-domain unit, a resource conflict indication sent by the second terminal device. The resource conflict indication is used to indicate that there is a reserved resource on which a conflict occurs in the target reserved resource. A location of the third time-domain unit in time domain is determined based on one or more of the following information: a location of the first time-domain unit in time domain; a location of the second time-domain unit in time domain; a time required for decoding the indication information by the first terminal device; a time required for preparing the resource conflict indication by the first terminal device; a time required for decoding the resource conflict indication by the second terminal device; and a time required for preparing, by the second terminal device, to transmit data on the reserved resource.

In a possible implementation, a time interval between the first time-domain unit and the third time-domain unit is determined based on the time required for decoding the indication information by the first terminal device and the time required for preparing the resource conflict indication by the first terminal device.

In a possible implementation, a time interval between the third time-domain unit and the second time-domain unit is determined based on the time required for decoding the resource conflict indication by the second terminal device and the time required for preparing, by the second terminal device, to transmit the data on the reserved resource.

In a possible implementation, the resource conflict indication is carried in a physical sidelink feedback channel PSFCH.

In a possible implementation, a time required for decoding the first PSFCH by the second terminal device is determined based on a time required for decoding sidelink control information SCI by the second terminal device.

In a possible implementation, the reserved resource on which a conflict occurs includes a plurality of reserved resources, and the plurality of reserved resources meet any one of the following conditions: that at least a part of the plurality of reserved resources is an initial transmission resource; that at least a part of the plurality of reserved resources is a retransmission resource; and that the plurality of reserved resources belong to a resource set that is reserved by the second terminal device and indicated by the resource indication information, a distance between each of the plurality of reserved resources and a time-frequency resource occupied by the resource indication information is less than a first distance, and the first distance is a distance between another reserved resource in the resource set except the plurality of reserved resources and the time-frequency resource occupied by the resource indication information.

FIG. 18 is a schematic structural diagram of a communications apparatus according to an embodiment of this application. Dashed lines in FIG. 18 indicate that units or modules are optional. The apparatus 1800 may be configured to implement the methods described in the foregoing method embodiments. The apparatus 1800 may be a chip or a terminal device.

The apparatus 1800 may include one or more processors 1810. The processor 1810 may support the apparatus 1800 to implement the methods described in the foregoing method embodiments. The processor 1810 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field-programmable gate array (FPGA) or another programmable logic device, a discrete gate or transistor logic device, a discrete hardware component, or the like. The general-purpose processor may be a microprocessor, or the processor may be any conventional processor or the like.

The apparatus 1800 may further include one or more memories 1820. The memory 1820 stores a program. The program may be executed by the processor 1810 to cause the processor 1810 to perform the methods described in the foregoing method embodiments. The memory 1820 may be independent of the processor 1810 or may be integrated into the processor 1810.

The apparatus 1800 may further include a transceiver 1830. The processor 1810 may communicate with another device or chip through the transceiver 1830. For example, the processor 1810 may send data to and receive data from another device or chip through the transceiver 1830.

An embodiment of this application further provides a computer-readable storage medium for storing a program. The computer-readable storage medium may be applied to the terminal device or the network device provided in embodiments of this application, and the program causes a computer to perform the methods performed by the terminal device or the network device in various embodiments of this application.

An embodiment of this application further provides a computer program product. The computer program product includes a program. The computer program product may be applied to the terminal device or the network device provided in embodiments of this application, and the program causes a computer to perform the methods performed by the terminal device or the network device in various embodiments of this application.

An embodiment of this application further provides a computer program. The computer program may be applied to the terminal device or the network device provided in embodiments of this application, and the computer program causes a computer to perform the methods performed by the terminal device or the network device in various embodiments of this application.

It should be understood that the terms “system” and “network” in this application may be used interchangeably. In addition, the terms used in this application are only used to illustrate specific embodiments of this application, but are not intended to limit this application. The terms “first”, “second”, “third”, “fourth”, and the like in the specification, claims, and drawings of this application are used for distinguishing different objects from each other, rather than defining a specific order. In addition, the terms “include” and “have” and any variations thereof are intended to cover a non-exclusive inclusion.

The “indication” mentioned in embodiments of this application may be a direct indication or an indirect indication, or indicate an association relationship. For example, if A indicates B, it may mean that A directly indicates B, for example, B can be obtained from A. Alternatively, it may mean that A indirectly indicates B, for example, A indicates C, and B can be obtained from C. Alternatively, it may mean that there is an association relationship between A and B.

In embodiments of this application, “B corresponding to A” means that B is associated with A, and B may be determined based on A. However, it should be further understood that, determining B based on A does not mean determining B based on only A, but instead B may be determined based on A and/or other information.

In embodiments of this application, the term “corresponding” may mean that there is a direct or indirect correspondence between two elements, or that there is an association relationship between two elements, or that there is a relationship of “indicating” and “being indicated”, “configuring” and “being configured”, or the like.

In embodiments of this application, “predefining” or “preconfiguring” can be implemented by prestoring corresponding code or a corresponding table in a device (for example, including a terminal device and a network device) or in other manners that can be used for indicating related information. A specific implementation thereof is not limited in this application. For example, predefining may indicate being defined in a protocol.

In embodiments of this application, the “protocol” may indicate a standard protocol in the communication field, which may include, for example, an LTE protocol, an NR protocol, and a related protocol applied to a future communications system. This is not limited in this application.

In embodiments of this application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

In embodiments of this application, sequence numbers of the foregoing processes do not mean execution orders. The execution orders of the processes should be determined according to functions and internal logic of the processes, and should not be construed as any limitation on the implementation processes of embodiments of this application.

In several embodiments provided in this application, it should be understood that, the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between apparatuses or units may be implemented in electronic, mechanical, or other forms.

The units described as separate components may be or may not be physically separated, and the components displayed as units may be or may not be physical units, that is, may be located in one place or distributed on a plurality of network units. Some or all of the units may be selected according to an actual requirement to achieve the objective of the solution of this embodiment.

In addition, functional units in embodiments of this application may be integrated into one processing unit, or each of the units may exist alone physically, or two or more units may be integrated into one unit.

All or some of the foregoing embodiments may be implemented by using software, hardware, firmware, or any combination thereof. When the embodiments are implemented by using software, the foregoing embodiments may be implemented completely or partially in a form of a computer program product. The computer program product includes one or more computer instructions. When the computer program instructions are loaded and executed on a computer, the procedures or functions in embodiments of this application are completely or partially generated. The computer may be a general-purpose computer, a dedicated computer, a computer network, or another programmable apparatus. The computer instructions may be stored in a computer-readable storage medium or transmitted from a computer-readable storage medium to another computer-readable storage medium. For example, the computer instructions may be transmitted from a website, computer, server, or data center to another website, computer, server, or data center in a wired (for example, a coaxial cable, an optical fiber, and a digital subscriber line (DSL)) manner or a wireless (for example, infrared, wireless, microwave, and the like) manner. The computer-readable storage medium may be any usable medium readable by a computer, or a data storage device, such as a server or a data center, with one or more usable media integrated. The usable medium may be a magnetic medium (for example, a floppy disk, a hard disk, or a magnetic tape), an optical medium (for example, a digital video disc (DVD)), a semiconductor medium (for example, a solid-state drive (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A communication method, comprising:
receiving, by a first terminal device in a first time-domain unit, resource indication information sent by a second terminal device, wherein the resource indication information is used to indicate a target reserved resource, in a second time-domain unit, of the second terminal device; and
sending, by the first terminal device, a resource conflict indication to the second terminal device in a third time-domain unit, wherein the resource conflict indication is used to indicate that there is a reserved resource on which a conflict occurs in the target reserved resource,
wherein a location of the third time-domain unit in time domain is determined based on one or more of following information:
a location of the first time-domain unit in time domain;
a location of the second time-domain unit in time domain;
a time required for decoding the indication information by the first terminal device;
a time required for preparing the resource conflict indication by the first terminal device;
a time required for decoding the resource conflict indication by the second terminal device; and
a time required for preparing, by the second terminal device, to transmit data on the reserved resource.

2. The method according to claim 1, wherein a time interval between the first time-domain unit and the third time-domain unit is determined based on the time required for decoding the indication information by the first terminal device and the time required for preparing the resource conflict indication by the first terminal device.

3. The method according to claim 1, wherein a time interval between the third time-domain unit and the second time-domain unit is determined based on the time required for decoding the resource conflict indication by the second terminal device and the time required for preparing, by the second terminal device, to transmit the data on the reserved resource.

4. The method according to claim 1, wherein the resource conflict indication is carried in a physical sidelink feedback channel (PSFCH).

5. The method according to claim 1, wherein the reserved resource on which a conflict occurs comprises a plurality of reserved resources, the plurality of reserved resources comprise a first reserved resource, and the first reserved resource is a sidelink resource, in the plurality of reserved resources, that is closest to a time-domain unit occupied by the resource indication information, in time domain.

6. The method according to any one of claim 1, wherein the reserved resource on which a conflict occurs comprises a plurality of reserved resources, and the plurality of reserved resources meet any one of following conditions:
that at least a part of the plurality of reserved resources is an initial transmission resource;
that at least a part of the plurality of reserved resources is a retransmission resource; and
that the plurality of reserved resources belong to a resource set that is reserved by the second terminal device and indicated by the resource indication information, a distance between each of the plurality of reserved resources and a time-frequency resource occupied by the resource indication information is less than a first distance, and the first distance is a distance between another reserved resource in the resource set except the plurality of reserved resources and the time-frequency resource occupied by the resource indication information.

7. A communication method, comprising:
sending, by a second terminal device in a first time-domain unit, resource indication information to a first terminal device, wherein the resource indication information is used to indicate a target reserved resource, in a second time-domain unit, of the second terminal device; and
receiving, by the second terminal device in a third time-domain unit, a resource conflict indication sent by the first terminal device, wherein the resource conflict indication is used to indicate that there is a reserved resource on which a conflict occurs in the target reserved resource,
wherein a location of the third time-domain unit in time domain is determined based on one or more of following information:
a location of the first time-domain unit in time domain;
a location of the second time-domain unit in time domain;
a time required for decoding the indication information by the first terminal device;
a time required for preparing the resource conflict indication by the first terminal device;
a time required for decoding the resource conflict indication by the second terminal device; and
a time required for preparing, by the second terminal device, to transmit data on the reserved resource.

8. The method according to claim 7, wherein a time interval between the first time-domain unit and the third time-domain unit is determined based on the time required for decoding the indication information by the first terminal device and the time required for preparing the resource conflict indication by the first terminal device.

9. The method according to claim 7, wherein a time interval between the third time-domain unit and the second time-domain unit is determined based on the time required for decoding the resource conflict indication by the second terminal device and the time required for preparing, by the second terminal device, to transmit the data on the reserved resource.

10. The method according to claim 7, wherein the resource conflict indication is carried in a physical sidelink feedback channel (PSFCH).

11. The method according to claim 7, wherein the reserved resource on which a conflict occurs comprises a plurality of reserved resources, the plurality of reserved resources comprise a first reserved resource, and the first reserved resource is a sidelink resource, in the plurality of reserved resources, that is closest to a time-domain unit occupied by the resource indication information, in time domain.

12. The method according to claim 7, wherein the reserved resource on which a conflict occurs comprises a plurality of reserved resources, and the plurality of reserved resources meet any one of following conditions:
that at least a part of the plurality of reserved resources is an initial transmission resource;
that at least a part of the plurality of reserved resources is a retransmission resource; and
that the plurality of reserved resources belong to a resource set that is reserved by the second terminal device and indicated by the resource indication information, a distance between each of the plurality of reserved resources and a time-frequency resource occupied by the resource indication information is less than a first distance, and the first distance is a distance between another reserved resource in the resource set except the plurality of reserved resources and the time-frequency resource occupied by the resource indication information.

13. A first terminal device, comprising a processor and a memory, wherein the memory is configured to store a computer program, and the processor is configured to invoke and run the computer program stored in the memory to cause the first terminal device to perform:
receiving, in a first time-domain unit, resource indication information sent by a second terminal device, wherein the resource indication information is used to indicate a target reserved resource, in a second time-domain unit, of the second terminal device; and
sending a resource conflict indication to the second terminal device in a third time-domain unit, wherein the resource conflict indication is used to indicate that there is a reserved resource on which a conflict occurs in the target reserved resource,
wherein a location of the third time-domain unit in time domain is determined based on one or more of following information:
a location of the first time-domain unit in time domain;
a location of the second time-domain unit in time domain;
a time required for decoding the indication information by the first terminal device;
a time required for preparing the resource conflict indication by the first terminal device;
a time required for decoding the resource conflict indication by the second terminal device; and
a time required for preparing, by the second terminal device, to transmit data on the reserved resource.

14. The first terminal device according to claim 13, wherein a time interval between the first time-domain unit and the third time-domain unit is determined based on the time required for decoding the indication information by the first terminal device and the time required for preparing the resource conflict indication by the first terminal device.

15. The first terminal device according to claim 13, wherein a time interval between the third time-domain unit and the second time-domain unit is determined based on the time required for decoding the resource conflict indication by the second terminal device and the time required for preparing, by the second terminal device, to transmit the data on the reserved resource.

16. The first terminal device according to claim 13, wherein the resource conflict indication is carried in a physical sidelink feedback channel (PSFCH).

17. The first terminal device according to claim 13, wherein the reserved resource on which a conflict occurs comprises a plurality of reserved resources, the plurality of reserved resources comprise a first reserved resource, and the first reserved resource is a sidelink resource, in the plurality of reserved resources, that is closest to a time-domain unit occupied by the resource indication information, in time domain.

18. The first terminal device according to claim 13, wherein the reserved resource on which a conflict occurs comprises a plurality of reserved resources, and the plurality of reserved resources meet any one of following conditions:
that at least a part of the plurality of reserved resources is an initial transmission resource;
that at least a part of the plurality of reserved resources is a retransmission resource; and
that the plurality of reserved resources belong to a resource set that is reserved by the second terminal device and indicated by the resource indication information, a distance between each of the plurality of reserved resources and a time-frequency resource occupied by the resource indication information is less than a first distance, and the first distance is a distance between another reserved resource in the resource set except the plurality of reserved resources and the time-frequency resource occupied by the resource indication information.

19. A second terminal device, comprising a processor and a memory, wherein the memory is configured to store a computer program, and the processor is configured to invoke and run the computer program stored in the memory to cause the second terminal device to perform the method according to claim 7.
